(19) United States
(12) Patent Application Publication
(10) Pub. No.: US 2019/0057340 A1
(43) Pub. Date: Feb. 21, 2019

(54) METHOD AND SYSTEM FOR AUTOMATED TIME MANAGEMENT

(71) Applicant: Kevin Sunlin Wang, Flushing, NY (US)

(72) Inventor: Kevin Sunlin Wang, Flushing, NY (US)

(21) Appl. No.: 16/166,034

(22) Filed: Oct. 19, 2018

Related U.S. Application Data
(63) Continuation-in-part of application No. 15/934,677, filed on Mar. 23, 2018.
Application No. 15/934,677 is a continuation-in-part of application No. 15/474,685, filed on Mar. 30, 2017.
(60) Provisional application No. 62/574,584, filed on Oct. 19, 2017.
(60) Provisional application No. 62/479,065, filed on Mar. 30, 2017.
(60) Provisional application No. 62/421,086, filed on Nov. 11, 2016.

(51) Int. Cl. G06Q 10/06; G06Q 10/10; G06F 17/30

(52) U.S. Cl. CPC G06Q 10/063114; G06F 17/30241; G06Q 10/109

(57) ABSTRACT

A method and system for automated time management is provided. The system is configured to track actual worktime and/or location of employees and independent contractors, predict potentially unauthorized additional worktime or overtime, automatically notify a supervisor of the potential overage, receive a decision with either an authorized adjustment to the worktime or a rejection, and communicate the decision to the employee or independent contractor. Time and location of employees and independent contractors are tracked and compared with an established field of acceptability for work requests involving designated locations and times. The field of acceptability may include the designated locations, as well as routes thereto and therefrom. The system computes a total work-time of the employee or independent contractor based on time periods where they are within the field of acceptability, and does not include time where they are not deemed within the field of acceptability.

### CROSS-REFERENCE TO RELATED APPLICATIONS

The present application is based on and claims priority to U.S. Provisional Pat. Appl. Ser. No. 62/574,584, filed on Oct. 19, 2017, and is a continuation-in-part of U.S. patent application Ser. No. 15/934,677, filed Mar. 23, 2018, which is based on and claims priority to U.S. Provisional Pat. Appl. Ser. No. 62/479,065, filed on Mar. 30, 2017, and is a continuation-in-part of U.S. patent application Ser. No. 15/474,685, filed on Mar. 30, 2017, which is based on and claims priority to U.S. Provisional Pat. Appl. Ser. No. 62/421,086, filed on Nov. 11, 2016, the disclosures of which are all hereby incorporated by reference herein in their entireties.

### FIELD OF THE INVENTION

The present invention relates to an intelligent time attendance tracking system and method, and more particularly, to a customizable system and method of tracking time attendance by continually and periodically receiving employee data such as location data, time data, employee codes, card swipes, biometric scans, or other means for indicating arrival, departure, and travel of employees to and from employment or other locations, and outputting one or more notifications or other communications to an employee, a system administrator, or a manager based on a comparison of the employee data with various pre-set configurations or a dynamically updated field of acceptability in accordance with pre-set rules.

### BACKGROUND OF THE INVENTION

Time attendance tracking and management systems typically include employee time clock systems which have mechanical or electronic punch clocks at workplaces to assist employers with tracking and managing employee worktime. Such time clock systems collect date and time information for employees and establish employee records. Management and payroll departments utilize the employee records to calculate the appropriate pay for each employee. While employees are often required to clock-in and clock-out when checking in or out of work, managing these records can be tedious and costly.

Various systems and methods for time attendance tracking are known in the art. Such systems may include a time clock installed within an office or work setting and configured to work in conjunction with swipe cards, punch cards, identity cards, etc. While certain aspects of such time tracking may be effective for employees within work premises, tracking employee attendance at work-related events or business trips, or in-route thereto or therefrom, may be difficult. Additionally, time tracking devices at a job site may be prone to improper use, damage, or malfunction.

Employee overtime can significantly impact operation costs in many industries. Thus, companies naturally desire to monitor and control overtime hours, and to ensure that such hours and the costs associated therewith are worthwhile. Some companies rely on paper records to track and approve overtime claims, which requires significant administration time and cost. While an electronic system can reduce administrative workloads, managers and/or superiors must still check each claim or request before giving approval. Further, managers and/or superiors often cannot preschedule or pre-authorize overtime schedules for staff within specific time periods. For example, in some circumstances, employees may only begin working overtime after their manager and/or superior authorizes them to do so, but may not receive timely approval. Additionally, employee needs may vary. Current time attendance systems still require significant supervisor or managerial time and expense to review all time clock transactions (e.g., clock-in, clock-out, etc.) for compliance with employee work schedules, approved overtime, and other rules and regulations, as well as to make appropriate corrections for payroll calculations.

These problems are compounded when employees frequently travel to remote locations for work, such as for sales, marketing, client meetings, prospecting, tradeshows, conferences, or simply to provide a service on behalf of the company (e.g., consulting, product installation, plumbing, electronics, presentations, etc.). Employees are often paid for travel to and from such appointments, or receive credit for the time spent travelling and meeting with clients. Establishing compliance with an employer's expectations may be very difficult as there is no way for the employer to know, for example, whether an employee was really stuck in several hours of traffic, whether the employee met with designated personnel or went to particular locations, etc. Additionally, there is no way for an employer to know whether an employee or independent contractor, while traveling or in between several time periods performing work for a client, stopped at, for example, a casino for several hours and falsely represented that the time was spent working, a potentially fraudulent activity. Technology-based verification features disclosed herein provide a technological solution to this problem, verify employee attendance and service, confirm unexpected deviations in time or location are due to reasonable or legitimate causes, and help management and supervisors to stay on top of employee and independent contractor work-time and prevent unauthorized hours before they occur. There is a need in the art for a system which can track time and location of employees both on-site and off-site, and provide a real-time communication platform to allow interaction between employees and supervisors to ease administrative workload.

### SUMMARY OF THE INVENTION

In view of the above recited deficiencies, there is need for a system and method that automatically monitors employee time and location compliance with work schedules and other presets, and that automatically transmits a communication alert or notification to a manager or system administrator with employee data concerning current and/or past compliance, prediction of compliance, employee hours, breaks, issues, and/or other business attributes for review and analysis. The following summary is not intended to identify or point to essential features or limit the scope of the subject matter claimed herein.

According to one aspect of the invention, a system for tracking work-time is provided. The system comprises a server communicatively coupled to one or more computing devices via a network, wherein at least one of the one or more computing devices includes a location identifier configured to generate location data corresponding to one or more locations, and the server includes at least one non-transitory computer-readable storage medium with computer-readable instructions stored therein, a database, and a processor for executing the computer-readable instructions to receive, from at least one of the one or more computing devices, a work request, the work request including one or more designated times and one or more designated locations; establish, by the server, a field of acceptability based on one or more predetermined rules, wherein the field of acceptability includes a first portion of aggregate data comprising at least one of (i) one or more location data sets corresponding to the one or more designated locations or (ii) one or more time-location data sets corresponding to the one or more designated times and the one or more designated locations; receive, from an employee computing device of an employee assigned to the work request, an actual location data set or an actual time-location data set generated by the location identifier during performance of the work request; continually determine compliance or noncompliance with the work request by comparing, in accordance with the one or more predetermined rules, (i) the actual location data set with the field of acceptability, or (ii) the actual time-location data set with the field of acceptability; and compute a total work-time of the employee on the work request based on at least one of determined compliance or determined noncompliance of the employee with the work request.

According to another aspect of the invention, a system for tracking employee work-time is provided. The system comprises a server communicatively coupled to one or more computing devices via a network, wherein at least one of the one or more computing devices includes a location identifier configured to generate location data corresponding to one or more locations, and the server includes at least one non-transitory computer-readable storage medium with computer-readable instructions stored therein, a database, and a processor for executing the computer-readable instructions to: receive, from at least one of the one or more computing devices, a work request, the work request including one or more designated times and one or more designated locations; establish, by the server, a field of acceptability based on one or more predetermined rules, wherein the field of acceptability includes a first portion of aggregate data comprising at least one of (i) one or more location data sets corresponding to the one or more designated locations or (ii) one or more time-location data sets corresponding to the one or more designated times and the one or more designated locations; receive, from an employee computing device of an employee assigned to the work request, an actual location data set or an actual time-location data set generated by the location identifier during performance of the work request; continually determine compliance or noncompliance with the work request by comparing, in accordance with the one or more predetermined rules, (i) the actual location data set with the field of acceptability, or (ii) the actual time-location data set with the field of acceptability; and compute a total work-time of the employee on the work request based on at least one of determined compliance or determined noncompliance of the employee with the work request. The present disclosure relates to a system for tracking employee worktime and location with the following objectives:

To provide a system and method which assists an employer or project manager to track, verify, and manage the time spent by individual employees or independent contractors at or in route to or from a designated job location or site, whether they are working online or offline, and to help minimize fraud, theft, and unnecessary overtime pay;

To provide a customizable time tracking system configured to receive employee data such as location data, time data, employee codes, card swipes, biometric scans, or other means for indicating arrival, departure, and travel of employees to and from employment or other locations, to store each transaction in a database, to compare the transaction with a customizable profile for each employee/user and/or a field of acceptability, and to output a notification or other communication to an employee, a system administrator, or a manager based on the comparison of the employee data with the customizable profile or field of acceptability in accordance with pre-set rules;

To provide a system and method that links employee check-in/checkout to a dynamically updated database and computing system which, based on pre-set preferences and customizable user profiles, outputs various notifications to employees and managers;

To provide a time-tracking system and method in which an input from an employee (i.e., code entry, card swipe, RFID, etc.) triggers the tracking system to transmit a feedback signal representative of the employee's presence at a workplace or other location within a predetermined work-shift time period;

To provide a time tracking system and method in which a lack of input from an employee (i.e., a lack of code entry, card swipe, RFID, or time-location data within an acceptable field) triggers the tracking system to transmit a feedback signal representative of the absence of the employee from the workplace or designated work location or route within a predetermined work-shift time period;

To provide a time tracking system and method in which input from an employee (i.e., code entry, card swipe, RFID, etc.) triggers the tracking system to transmit a departure feedback signal representative of the employee's departure from the workplace or other designated location at an identified time;

To provide a system and method configured to, each time an employee locally checks in or out or remotely transmits a work related start or end input, record the transaction in a database with a corresponding timestamp, compare the transaction and timestamp with a customizable employee profile corresponding to the particular employee who is checking in or out, and based on this comparison, send an output (e.g., a written notification or other communication) to employees, managers, independent contractors, and/or system administrators;

To provide a time tracking system and method for improving employee morale by, for example, providing one or more outputs at the time of certain transactions, such as singing “Happy Birthday” to the employee on his/her birthday, providing notification(s) to an employee's colleagues announcing the employee's birthday, playing an employee's favorite song, issuing a simple greeting like “Good Morning [Employee Name],” informing the employee that he/she is late for work, providing general corporate announcements to employees, etc, all on a workplace punch clock or remote computing device associated with the employee;

To provide a time tracking system and method configured to notify a manager or system administrator (MSA) when an employee checks in or out at a time which is not within the employee's regularly scheduled working hours or within a pre-set time-frame for any deviation(s) from the employee's regular schedule;

To provide a time tracking system and method that notifies the MSA when the employee is projected to exceed a certain predetermined number of work hours in a given time frame (e.g., the employee is about to exceed or is predicted to exceed a 40 hour work week or other work amount sufficient to qualify for overtime);

To provide a time tracking system and method configured to notify the MSA when the employee does not locally or remotely check in or out within a pre-set time period of a regularly scheduled start time or a regularly scheduled end time, or when any aberrations occur with respect to the employee's working time;

To provide a system and method that allows the employees to record their attendance at a location even when they are on business trips and/or visiting customers at remote locations, through network connections between a server and their hand-held devices;

To track time attendance of employees by using employee's personal hand-held device with location tracking to avoid “buddy punching” and reporting of fake time attendance by a third party;

To provide a time and location tracking system and method directed to encourage employee productivity through observing their work habits;

To provide a system and method that provides detailed attendance records whereby the productivity of a workforce can be monitored, controlled and corrected;

To provide a customizable service or payment verification system and method for employee services based on a predetermined set of rules for establishing a field of acceptability for travelling to and from work locations or remote locations, and for performing and verifying such travel and services;

To provide various sets of indicators to display to employees to facilitate their compliance with an established field of acceptability for one or more designated work locations and one or more travel routes; and

To provide a time and location tracking system and method in which employees and employers can interactively communicate with one another regarding work scheduling and approval.

Other objects, features, and characteristics of the present invention, as well as the methods of operation and functions of the related structural elements, and the combination of parts and economies of development and manufacture, will become more apparent upon consideration of the detailed description below with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings in conjunction with the following description. The drawings are not intended to limit the scope of this invention, which is set forth with particularity in the claims as appended or as subsequently amended, but merely to clarify and exemplify the invention.

Accordingly, a more complete appreciation of the present invention and many of the attendant aspects thereof may be readily obtained as the same becomes better understood by reference to the following detailed description when considered in conjunction with the accompanying drawings, where:

FIG. 1 is a schematic diagram of a customizable employee time tracking system, including a computing system and one or more peripheral computing devices for use in accordance with exemplary embodiments of the invention;

FIG. 2 is a diagram illustrating an exemplary structure of data stored in a database, and how organization of the data may be carried out in accordance with exemplary embodiments of the invention;

FIG. 3 is a diagram of an exemplary employee computing device and associated components in accordance with exemplary embodiments of the invention;

FIG. 4 is a schematic diagram further illustrating exemplary system components for employee work-time and work-location tracking in accordance with exemplary embodiments of the invention;

FIG. 5A is a flowchart illustrating an exemplary workflow for continuously tracking employee hours based on the employee's current work or service at one or more remote locations in accordance with an exemplary embodiment of the invention;

FIG. 5B is a flowchart illustrating an approach for mapping a geolocation to a designated location when the geolocation is within a field of acceptability of the designated location, in accordance with an exemplary embodiment of the invention;

FIG. 5C is a flowchart illustrating an approach for adjusting a designated time corresponding to an employee arrival or departure to an actual time of the employee arrival or departure when the actual time is deemed to be within the field of acceptability in accordance with an exemplary embodiment of the invention;

FIG. 6A is a flowchart illustrating an approach for establishing and updating the field of acceptability in accordance with an exemplary embodiment of the invention;

FIG. 6B is a flowchart illustrating an approach for establishing a temporary field of acceptability in certain circumstances in accordance with an exemplary embodiment of the invention;

FIG. 6C is a flowchart illustrating an approach for updating the temporary field of acceptability in accordance with an exemplary embodiment of the invention;

FIG. 7 is a diagram illustrating the application of the field of acceptability based on distance in accordance with an exemplary embodiment of the invention;

FIG. 8 is a flowchart illustrating an alternative approach for creating a temporary field of acceptability and updating the permanent field of acceptability in accordance with exemplary embodiments of the invention;

FIG. 9A is a schematic diagram of a local employee tracking system according to an exemplary embodiment of the present invention;

FIG. 9B is a schematic diagram of a notification on an employee computing device or a supervisor device in accordance with exemplary embodiments of the invention;

FIG. 10 illustrates a time clock mechanism of a local employee tracking system of FIG. 9A for use in accordance with an exemplary embodiment of the invention; and

FIG. 11 is a flowchart illustrating exemplary steps for tracking, monitoring, and processing the status of an employee's attendance or absence from work according to an exemplary embodiment of the invention.

### DETAILED DESCRIPTION OF THE INVENTION

The present disclosure is not intended to be limited to the specific terminology so selected, and it is to be understood that each specific element includes all technical equivalents which operate in a similar manner. As required, a detailed illustrative embodiment of the present invention is disclosed herein. However, techniques, methods, systems, compositions and operating structures in accordance with the present invention may be embodied in a wide variety of sizes, shapes, forms and modes, some of which may be quite different from those in the disclosed embodiment. Consequently, the specific structural, functional and step-by-step details disclosed herein are merely representative, yet in that regard, they are deemed to afford the best embodiment for purposes of disclosure and to provide a basis for the claims herein which define the scope of the present invention.

In the following detailed description, specific embodiments that may be practiced are shown by way of illustration and explanation. The embodiments are described in sufficient detail to enable those skilled in the art to practice the embodiments, and it is to be understood that the logical, mechanical, and other changes may be made without departing from the scope of the embodiments. The following detailed description is therefore not to be taken in a limiting sense. In describing exemplary embodiments of the present invention illustrated in the drawings, specific terminology is employed for sake of clarity. However, the present disclosure is not intended to be limited to the specific terminology so selected, and it is to be understood that each specific element includes all technical equivalents which operate in a similar manner. For example, elements and/or features of different exemplary embodiments may be combined with each other and/or substituted for each other within the scope of this disclosure and appended claims. In the description of the figures below, it is understood that the details described above may be combined with, or may be used in place of similar attributes described below and that the figures are used only to illustrate particular exemplary embodiments of the present invention.

It is to be understood herein that the methods and systems described may be implemented in at least hardware, software, or firmware, and may employ specifically configured processors or special purpose processing means. Such methods and systems may utilize software-implemented instructions stored on one or more devices that are tangibly embodied, such as a semiconductor memory device (e.g., RAM, ROM, PROM, EEPROM, or Flash-Programmable RAM), a magnetic memory device (e.g., a diskette or fixed hard disk), an optical memory device (e.g., CD-ROM or DVD), a PC card (e.g., PCMCIA card), or other memory device. Those instructions may be implemented by any suitable device with suitable architecture. Further, it will be appreciated by one of ordinary skill in the art that since these systems may be implemented in software, the constituent system components may differ in certain exemplary embodiments in response to how an application is programmed.

The methods and systems disclosed herein may be in part embodied in one or more servers. Each server or servers may be employed for one or more specific functions. A database server may be used to deploy one or more databases and optimize database queries. A server may be configured to act as the network server, and connection to one or more peripheral devices (e.g., a mobile device or one or more remote devices such as a computer or employee to client synced device(s) at another location) may be established. Such connections may be accomplished through a communication means or communications interface, which can incorporate any means for communicating at least data over one or more networks or to one or more peripheral devices connected to the system. Appropriate communication means may include, is not limited to, circuitry and control systems for providing wireless connections, wired connections, cellular connections, data port connections, Bluetooth connections, or any combination thereof. Numerous communications means may be utilized with exemplary embodiments of the invention.

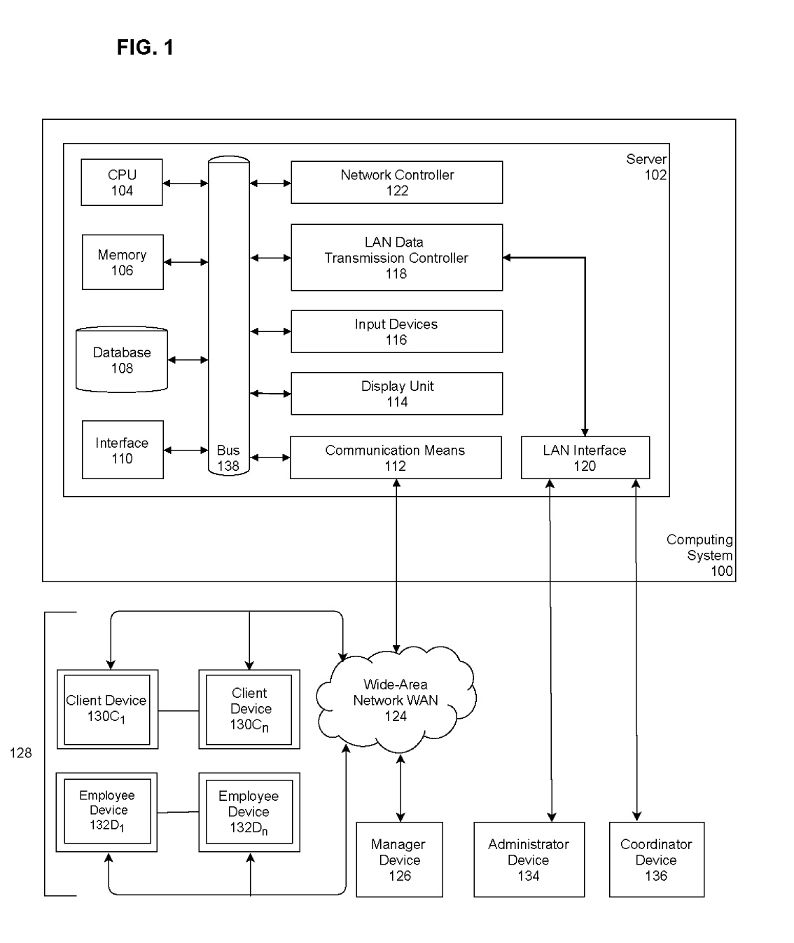

The systems and methods described herein are best understood with reference to the following drawings, which are described in detail below. Referring first to FIG. 1, illustrated is a diagram of an exemplary computing system 100 and a plurality of peripheral computing devices 128. A combination of hardware and software operate on the plurality of computing devices 128 and computing system 100, generally with one or more connections to wired or wireless wide area network (WAN) 124 (e.g., the Internet), and are incorporated with local devices through local area network (LAN) interface 120. Computing devices 128 can be a wireless mobile hardware device having software capable of communicating information to other mobile devices or computer systems, determining the location of that device with geographical position location capability (e.g., through triangulation of a cell system, GPS, specifically input by a user, etc.), and connecting to a private computer network or public network such as the Internet through a network.

Computing system 100 can include, for example, server 102 including central processing unit (CPU) 104, memory unit 106, database 108, interface 110, communication means 112, display unit 114, one or more input devices 116 (e.g., keyboard, mouse, etc.), LAN data transmission controller 118, LAN interface 120, network controller 122, and internal bus 138. As shown, the system may be connected to a data storage device, such as, for example, a hard disk disposing one or more databases 108 via a wired or wireless link. Computing system 100 can include one or more servers configured the same or similar to server 102 shown in FIG. 1, or one or more servers configured in a different manner, which may dispose different hardware or software. For example, computing system 100 may comprise multiple servers hosted in multiple spaces such as data centers or server farms.

Computing system 100 may be configured to communicate with network service(s) coordinated through communication means 112, which may include any approach for communicating data over one or more networks or to one or more peripheral devices.

Communication means 112 may include, but is not limited to, circuitry and control systems for providing wireless connections, wired connections, cellular connections, data port connections, Bluetooth connections, or any combination thereof, and the means may include devices enabled to communicate using such communication approaches. One of ordinary skill in the art will appreciate that there are numerous approaches to communications that may be utilized.

Server 102 and computing system 100 may be communicatively linked, through communication means 112 and WAN 124, to peripheral devices such as computing devices 128, manager device 126, administrator device 134, and coordinator device 136. Computing devices 128 may include one or more client computing devices 130C₁-130Cn and employee computing devices 132D₁-132Dn (or independent contractor computing devices). Computing devices 128 may be devices (e.g., smartphone, smartwatch, etc.) which allow a user (e.g., an employee, an independent contractor, a client, etc.) to interact with the computing system 100. Any number (e.g., 1, 2, 3, . . . n) of employee devices 132D₁ . . . 132Dn, or client devices 130C₁ . . . 130Cn may be used in conjunction with computing system 100.

It will also be appreciated that remote computing devices 128 may additionally or alternatively include non-smartphone(s) (i.e., traditional cellphones, landline telephones, etc.) that may connect with computing system 100 through a network. The central server may preferably work in conjunction with a database to store previous employee work/service information for the company or one or more clients of the company, such that it may later utilize the data to match the employee's voice or a client's voice to a log associated with previous work done by the employee for the company or for a client. An automated response by an interactive voice response (IVR) system may inquire as to whether a new work request is the same type of service/work most previously completed. For example, a client communicating with system 100 may be given a chance to choose “yes” or “no” or to select from a number of options, so that the work request can be processed automatically. Alternatively, a telephone system may prompt the client (or internal company manager) to verbally provide new service/work request details. Once this is processed, the system will automatically respond with one or more of employee details, scheduled day for work, estimated time of arrival (ETA) information, etc.

Computing system 100 may have more than one server 102 in a distributed structure with support from data centers that may be located anywhere around the world. These implementations may be communicatively linked and cross-platformed so that a user on a mobile device (e.g., smartphone, tablet, etc.) or stationary device (e.g., desktop computer, landline telephone, etc.) may be provided with information (e.g., electronic map displays, indicators which display travel times, routes, pricing information, profile information, settings information, level of familiarity, a notification to the employee of the employee's presence at an authorized or unauthorized location, etc.). The term indicator as used herein is a means to transmit or display information related to an employee, independent contractor, and/or client in a simple, fast, and convenient way. Features of the systems described herein can be implemented through computing devices that allow for method steps to be processed and output by a processor. Server 102 preferably coordinates user interfaces and interacts with database 108. Each user, depending on that user's role and needs, may be provided with a different functionality.

Server 102, through a server interface, may receive employee, company, or client input information, location information, and work request information to configure content, as well as real-time and historic information from the employee (e.g., location and time information, limitation information, historical information, etc.). As discussed above, server 102 can send information to one or more computing devices through server interfaces, and information can be output to a display of the computing devices. Such content can include features which are region-specific if particularly relevant regional information exists, especially with respect to work request mapping or routing.

The work request information received through the server interface may be stored by the computing system 100 in database 108, and may include, for example, the status of work requests, the status of work request acceptances by employees or independent contractors, one or more reasons why employees cancelled work requests, histories associated with assigned work requests, current or past operation logs, etc. The content/timestamps of notifications and confirmation statuses may also be recorded in system logs, and this information can be checked by the administrator of computing system 100. It will be appreciated that this information is not an exhaustive list, and that the system may record and store additional or alternative information.

The data stored in one or more databases 108 of computing system 100 can be continually updated with all user information discussed herein and analyzed in accordance with the various methodologies discussed herein to enable efficient employee work tracking, booking of work or service requests by the company or client(s), total employee work hours, etc. In certain embodiments, each time computing system 100 receives an input/request from a company employee, independent contractor, or an external client, computing system 100 can first open a safe access channel with database(s)/database center and then send query sentences through the access channel to a database management module. If a relational database is utilized, then the data tables may have one kind of relationship, such as one to many relationships, many to many relationships, and one to one relationships with other data table(s). Based on the relationships between data tables, the database(s) management module can exactly follow the query sentences and find the specific data table(s) by using ID(s), table names and column names of the tables with/without joining two or more data tables together. If a non-relational database is utilized instead of data tables, with the data stored in key-value pairs, then the database management module can exactly follow the query sentences and find the specific data by using keys that query sentences provide.

Computing system 100 can access all information stored in one or more databases 108, which may include rules and procedures data, employee data, administrative data, group data, client data, map component data, and any other data relevant to implementation of computing system 100. Employee rules and procedures data can include system price, promotion setting rules and procedures, as well as rules and procedures for indicators, referrals, payments, work requests, system management, system log, system analysis, optimization, etc. Map component data may also be stored in database 108, and can include map data (e.g., maps, directions, locations etc.) associated with work requests identified by the GPS and location-based works (LBS). The GPS and LBS data can determine the location of the computing devices in different ways, such as, for example, through receiving location-based resources. Employee data can include employee profiles, such as personal data including a photo of the employee, years of his/her experience, certification levels, gender, country of origin, language abilities, reviews, prior work requests completed, and data associated therewith.

Comprehensive database 108 may also store the details of work requests (internal to the company or external for one or more clients) for each particular employee for future reference. Database 108 can also include data in the employee's profile that may include such information as an employee's limitations related to zip codes, time, location, and price, as well as work data and records. It will be appreciated that there are numerous methods of providing databases and data storage media for the organization and retrieval of specific data, and that the exemplary embodiments of the invention may be contemplated for use with any appropriate database(s) or storage means. In certain implementations, database 108 can be located and accessed remotely. Further, while referenced as a database, it will be appreciated that database 108 may include a data storage medium, whether structured or unstructured, relational, or otherwise. Database 108 may be dynamically updated as work requests or services are booked and/or completed by employees or independent contractors. Database 108 may store an index of each work request that has been requested and completed, which can be retrieved for reference if needed at any time, as well as store the details of work requests or payment requests organized for each particular employee, client, manager, or employee for future reference.

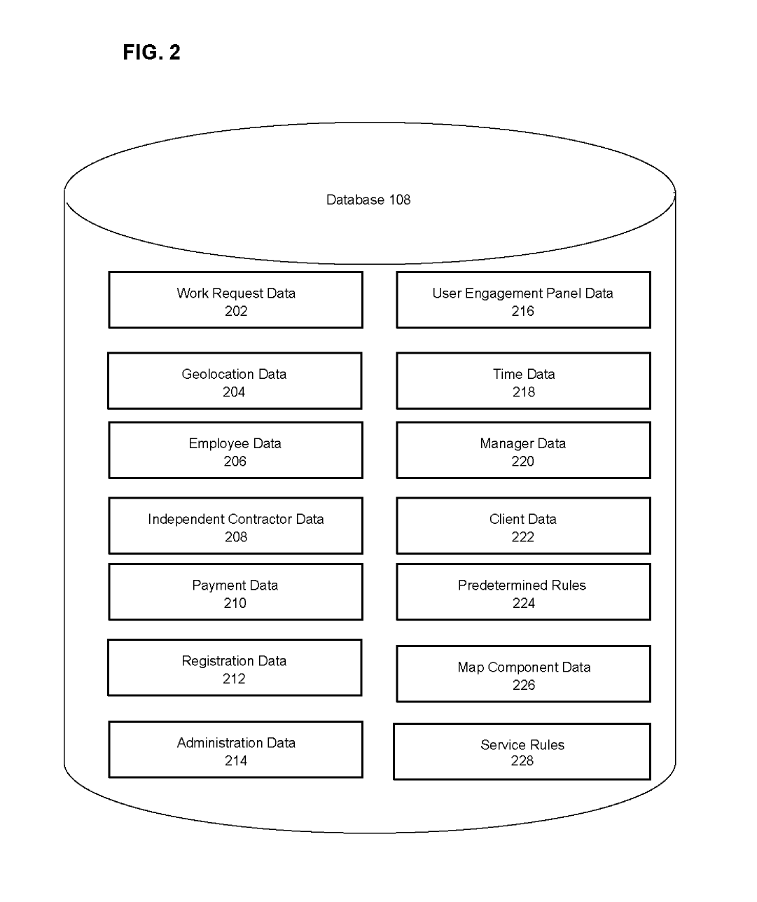

As depicted in FIG. 2, database 108 may contain work request data 202, such as when and from where a work request was made (e.g., internally or externally), who made the work request (e.g., a company manager or an external client), who provided the work request (e.g., a company employee or independent contractor), the name of the employee or independent contractor, the client involved, if any, etc. Additionally, any data provided through user engagement panel 314 (stored as user engagement panel data 216), may be stored in its own category with subcategories thereof. Database 108 may also store geolocation data 204, such as the designated and actual geolocations as well as buffer parameters and/or a field of acceptability for each geolocation and/or designated time (further discussed below). In addition, database 108 may store time data 218, also regarding the buffer parameters and/or the field of acceptability relevant for time adjustment. Database 108 may also store employee data 206, manager data 220, independent contractor data 208, and client data 222. This data may reflect any and all records each user may generate, which may include employee profiles, work history, etc. Database 108 may also store payment data 210, and be configured to categorize and store predetermined rules 224 that define the field of acceptability. Those rules may be associated with certain employee work requests, one or more locations or times, one or more employees, one or more independent contractors, one or more clients, etc. In this manner, one or more servers 102 can retrieve the applicable predetermined rules from database 108 when needed. In addition, database 108 may store registration data 212 of all users. Additionally, database 108 may store map component data 226 which may be queried for use as a GIS map layer or for other relevant purposes. Map component data 226 may contain data retrieved from a third-party geocoding application program interface (API) such as GOOGLE MAPS. Further, database 108 may be configured to store data related to system administration in administration data 214, service rules 228, as well as any other relevant employee data.

One of ordinary skill in the art will appreciate that database 108 may be configured to sync dynamically so that whenever changes or updates in data blocks are made, server 102 and database 108 dynamically update the data accordingly to reflect the latest changes. Additionally, at least one backup database may be utilized to back up a primary one of databases 108 in case of data loss in the primary database 108. One of ordinary skill in the art will appreciate that database 108 components may vary from the ones depicted herein.

Alternatively, computing system 100 may use a set of databases or data storage mediums to provide and maintain a prescheduled service application in order to instruct or dispatch a compatible employee based on an external work request from a client of the employee's company, and based on the client's preferences and needs. Databases 108 may contain several data categories or groupings. Sections (e.g., categories or groupings) of database 108 may be independent or synchronized in order to retrieve information from multiple sections at the same time. Such data can include predetermined rules data 224, procedures data, administrative data 214, client data 222, employee data 206, independent contractor data 208, group data, company data, or data associated with a group of individuals. All historical information may be categorized and stored in and retrieved from database 108. Historical data can be tracked in part by assigning a tracking number, service ID number or service ID corresponding to each work request to help computing system 100 refer back to the work request. Information categorized with this identification may include the type of work request, who requested the work request, who carried out the work request, where it took place (e.g., zip code, borough, county, city, state, etc.), the cost of the work request, when and how payment for the service took place, etc. All information regarding a client's or employee's preferences or limitations, pricing, and other customizable information can be stored within database 108.

The work request information stored in the database 108 may include, for example, a work request ID, relevant employee information, relevant client information, designated or requested work location(s), actual location(s), start time(s), end time(s), distance(s), duration time, status, prices, etc. Database 108 may store employee profile information, including first name, last name, username, email, password, phone number, date of birth, gender, country of origin, employee type, affiliated company name, language, signature, and general user profile(s). The relevant service information may also include, for example, client or company information. Additional data may be input into database 108, including, but not limited to, locations at which employees or independent contractors performed work or work related tasks, including locations such as those travelled to within the company or client locations, work solicitation, meeting with clients, performing work, etc.

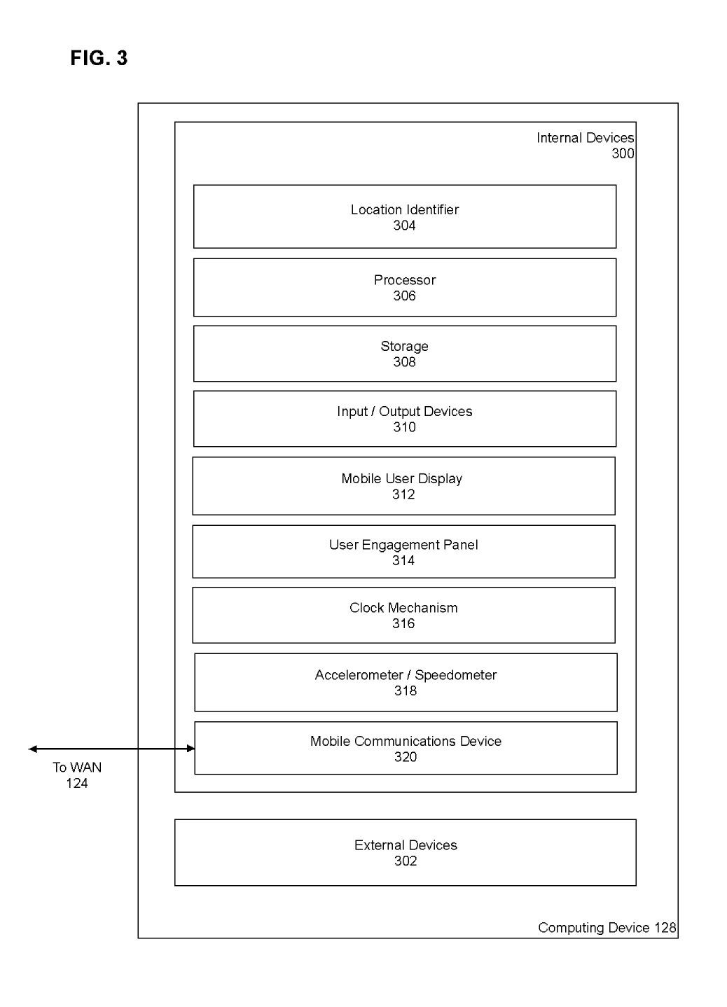

Turning now to FIG. 3, shown is a diagram illustrating various components of an exemplary embodiment of computing devices 128. As discussed above, computing devices 128 can be used by clients (e.g., via devices 130C₁ . . . 130Cn) or employees or independent contractors (e.g., via devices 132D₁ . . . 132Dn), and may be in communication with various components, tangible or intangible, of computing system 100. Computing devices 128 may incorporate various internal devices 300 and external devices 302, and may utilize mobile communications device 320 for receiving voice, text, and/or data for connecting to computing system 100 such as over WAN 124, and location identifier 304 such as a GPS receiver or GPS unit for identification of a past, present, or future location. An application, a map component, map data, and location identifier 304, such as, for example, a GPS module or other circuitry for providing LBS data may be integrated into one or more of computing devices 128 for certain location identification functions. Location identifier 304 may identify a location of computing devices 128 in different ways, such as, for example, through receiving location-based resources. One of ordinary skill in the art will appreciate that there are numerous approaches for providing location identification and location-based services. A GPS-enabled system or device allows tracking components to identify the location of computing devices 128. For example, location identifier 304 can be realized through processing received GPS data from location-based or geo-aware resources of computing devices 128. Additionally, location identifier 304 can receive GPS data from other applications or programs that operate on the computing device using one or more APIs. The application can use location information to cause a user interface component to configure a user interface framework.

Computing system 100 may be configured to generate, for example, a notification to a client device 130 when an employee comes within a region that is a certain distance (e.g., one or two miles) of a client location designated in a work request (or to an employee device 132 or manager device 126 when the employee come within a certain distance of a company location to which the employee is travelling). Such location-based services, facilitated by location identifiers 304 in employee devices 132D₁ . . . 132Dn, allow for efficient routing of employees based on point-to-point directions. Employee devices 132D₁ . . . 132Dn may each include an interface component which provides location information gathered by location identifier 304 and passes such location information to an interface component on client device 130C₁ . . . 130Cn via WAN 124 and server 102. Employee devices 132D₁ . . . 132Dn may also include radio-frequency identification (RFID) technology, or other similar identification device or means.

Location identifier 304 can include a GPS-enabled system or device whose tracking components identify the locations of employees, as well as locations of clients who subscribe to system 100 and allow access to their personal hand-held devices 130. While the invention is primarily discussed as incorporating or utilizing GPS technology, other tracking services such as China's BeiDou network, Russia's GLONASS service, India's IRNSS having the operational name NAVIC, Japan's QZSS, and Europe's Galileo network, etc. may also be employed as or part of the location identifier in accordance with exemplary embodiments of the invention. Computing system 100 may include an application manager which, based on a client's current location or service location, may cause a region-specific client interface feature to be outputted by a client interface component on mobile user display or user device 312. As used herein, a service or work location is a location initially designated as the location at which the employee's or independent contractor's work/services are to be provided, which may include a certain area or region around a geolocation point as determined by predetermined rules. The region may be identified by zip code, city name, metropolitan area name, etc., in which computing devices 128 are currently located, and may be an area having a certain distance or radius from a company location or a client's current location (e.g., one mile, five miles, etc.), or may be an area specifically partitioned from other areas. Region-specific information about a prescheduled work request or service may be provided in part by a system which supplies employee location data using location identifier 304. It will be appreciated that use of location related preferences or limitations may depend in part on GPS-enabled devices. By cross-referencing data, service systems described herein can identify specific locations (e.g., stores, restaurants, apartment complexes, factories, venues, street addresses, etc.) proximate to and/or located at an identified or designated location, and provide this specific location information as location data (e.g., as part of employee and client pair map component data 226).

Processor 306 is preferably provided for executing software or a set of instructions on computing devices 128. Computing devices 128 may also contain storage 308 such as random-access memory (RAM) or flash storage. Input/output (I/O) devices 310 can be used to connect computing devices 128 to other system implements, depending on the available functionalities of computing devices 128. For example, an employee may use an in-vehicle navigation system, which might not have a camera, while a smartphone may have a built-in camera. In this situation, a camera may be included as an input for the in-vehicle navigation system. Other I/O devices 310 may include a scanner, a microphone, and/or a speaker. Computing device 128 may also include mobile user display 312 to receive and display to a user notifications and/or other data received from computing system 100. Mobile user display 312 may, for example, be an electronic touchscreen display configured to provide user engagement panel or interface 314 in accordance with various methodologies of the invention. Computing devices 128 may also utilize internal clock mechanism 316 to determine the time the devices were at a given location. Accelerometer/speedometer 318 can also be provided as part of or in communication with computing devices 128 to measure speed, acceleration, directional changes, etc.

User engagement panel or interface 314 displays various content based on user selections and preferences. It will be appreciated that one or more components of computing devices 128 may be combined to provide user features specific to user selections and user locations. These selections can be displayed to the user, and the user can utilize user engagement panel or interface 314 to interact with displays of certain information. For instance, user engagement panel or interface 314 can correspond to a program downloaded onto a smartphone or other portable computer device such as a tablet computer or personal digital assistant (PDA). A user can download and install the application on one or more computing devices 128 and register with the system. Pre-programmed features of computing devices 128 may be utilized based on certain protocols or methods of integration of basic components, such as servers, databases 108, mobile end applications, web portals, network settings, etc.

All types of users can be registered and entered within the system for the purpose of activity tracking. Registration may be performed through means such as assigning a user ID to each user such that system functionalities can only be accessed when a user ID is entered. Additionally, the device the user employs to access the system may be tracked by an Internet Protocol (IP) address, and system activity may be tracked with timestamps or similar means and stored in database 108. In this manner, a system administrator can track not only who is accessing the system, but also from which device, the location of the device, and the time of such access. Such capabilities allow coordinators or managers to track activity, and if an error occurs, such as entry of a wrong address on a work request, then the cause of the error can be easily diagnosed and addressed. It will be appreciated that such functionality also provides a means for added security. Any work request entered from an unauthorized computer can be ignored. Unless computing device 128 is given access permission, it cannot access certain functionalities restricted to registered users.

User engagement panel or interface 314 can be, for example, a homepage, access to a dispatch portal (for employees), a work requesting module (for clients), an access interface to database 108, or a way for users to access one or a combination of any of the features described herein. The system can retrieve a user's information and other data that is stored in database 108, which may be provided locally and/or remotely. One of ordinary skill in the art will appreciate that numerous additional user interfaces are contemplated for use with or in place of user engagement panel or interface 314.

Client devices 130C₁ . . . 130Cn may each utilize a client interface to display various indicators on maps showing geographic information. Each indicator can signify, for example, differing employee or client information, or inputs received by computing system 100 from the employee, client, vender, etc. Client devices 130C₁ . . . 130Cn can also each contain application features adapted to dynamically synchronize content based on client selections provided via a client input. User engagement panel or interfaces 314 on client computing devices 130C₁ . . . 130Cn can include, but are not limited to, a home page client interface, a work request panel used for clients to identify the details of work requests, preference details, etc., a summary client interface, a location search client interface, a confirmation page interface, or a combination of any of these features. By way of example, if a client's current location is different from an originally requested location, then the client can manually preschedule a new location for service different from the current location stored in computing device 128 or computing system 100. In other embodiments, manager device 126, administrator device 134, and/or coordinator device 136 may be equipped with the same functionality and used by the company's managers, administrators, or coordinators, respectively, to enter work requests for employees of the company.

In certain embodiments, a start button functionality can be provided as part of computing device 128 on, for example, one or more of employee devices 132D₁ . . . 132Dn. Display 312 of one or more mobile employee device 132D₁ . . . 132Dn may display relevant information to an employee about the service queue, starting with the next service in the queue, where the details of the service are shown, such as the location and start time along with the destination and the scheduled end time (e.g., installing cable television at a customer's apartment). The employee can click ‘Start’ (e.g., via a physical push button or via a touch screen interface on employee device 132D) in order to let an administrator of the company know that he/she has begun the service and is on the way. Mobile user display 312 may also show a list of the remaining services in the queue with limited details, which may be expanded or viewed later.

The user interface may also include a Start button which triggers a series of events in database 108 regarding data storage. The geolocation of the employee may be tracked by location and time with location identifier 304 as part of the records associated with a work request, the client, the employee, etc. It will be appreciated that without this Start button functionality, GPS devices may still be able to detect an employee's current location and heading. However, when providing services to clients, employees may have a long list of scheduled work requests, and without an employee actually confirming that he/she is underway to provide service to a particular client, there is no way to be sure that the location which the employee seems to be heading towards is the client's location. As a result, the Start button is a powerful feature that can provide company coordinators, managers, and other parties with an instant update on the employee's real-time status.

In preferred embodiments, system 100 dynamically updates and stores any changes to a work request before or during the start thereof, or any updates on the status of the work request and displays these changes in real-time, both in a web portal for the coordinator, and in an employee interface on employee device 132 associated with the employee assigned to the work request. For example, if a client cancels a work request or needs to change the start time or location, the client can enter this information into system 100 via client device 130. The new information is stored in database 108. The web portal of the coordinator updates, and a notification of the change is immediately sent to the employee associated with the work request via an employee device 132. The employee can then preferably access the same information about the work request displayed in the web portal of the coordinator. Additionally, in preferred embodiments, any new information about the client (e.g., phone number, email address, a change to preferences, etc.) entered prior to the work request can be communicated to the web portal of the coordinator and the user interface of employee device 132 of the employee assigned to the work request. Preferably, only relevant employee devices are updated with new client information (e.g., employee devices associated with employees involved with the client's work requests).

External devices 302 (i.e., additional mobile devices, tablets, laptops, or other computing devices) can connect to computing devices 128 through a wired or wireless connection. It will be appreciated that these external devices 302 may include any device that can provide additional or enhanced functionalities to computing devices 128, whether computing devices 128 is a mobile device such as a tablet or smartphone, an in-vehicle navigation system, or another type of computing device.

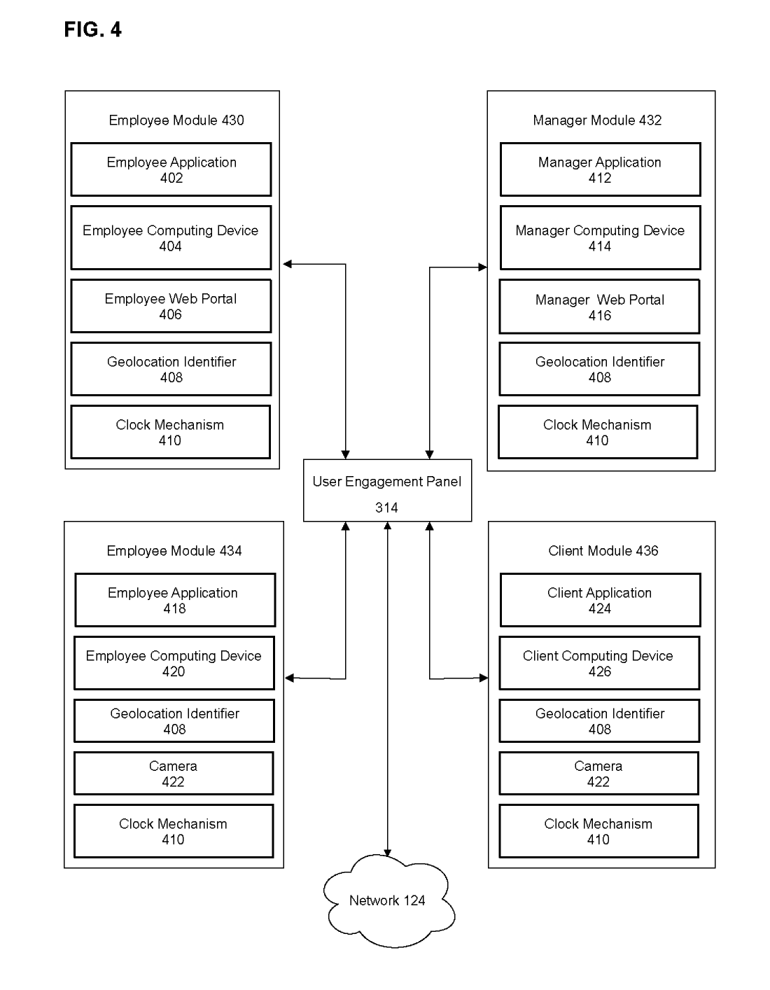

Shown in FIG. 4 is a schematic diagram further illustrating system components for an employee tracking system in accordance with an exemplary embodiment of the invention. Employee module 430 may include employee application 402, which may be software running on employee computing device 404 such as a desktop computer or remote touch screen device, or include a keyboard and/or a mouse or other input devices. An employee can enter commands and information into the system through employee module 430 running on employee computing device 404. Other input devices can include a microphone, tablet, smartphone or other mobile device. Additional functionality may be provided through a scanner, etc. These and other input devices are connected to one or more servers through an interface. Employee application 402 may be in the form of different apps such as desktop app, Android apps, iOS apps, or Windows OS apps, etc., and may run on a computing device, such as a mobile device. Employee module 430 in part allows an employee to connect to employee web portal 406, in which certain employee related information may be made available. Employees may be provided features unique to their job functions.

Employee module 434 may include employee application 418, which may be carried out on employee computing device 420. Employee module 434 allows tracking components such as geolocation identifier 408 (e.g., GPS receiver or GPS unit) to identify the geolocation of an employee. Geolocation identifier 408 may be built into a mobile device or part of a specially programmed verification device. In other exemplary embodiments, geolocation identifier 408 may be mounted in a vehicle operated by an employee and may communicate through network 124 with one or more servers 102 with means for geolocation tracking and/or processing. Employee module 434 may also use camera 422 to take pictures, and clock mechanism 410 to obtain timestamps. These may be part of employee computing device 420, such as built into a smartphone, or may be input devices or potentially functionalities provided by an additional specially programmed verification device. Camera 422 may allow the employee to take a photo of a certain location, and that photo may be image processed. The photo may be processed using image-recognition technology to cross-reference the photo with known location images.

For example, an employee arriving at a client's office for an appointment may be able to take a photo of the entrance to the client's office, which may be recognized by the system. The system may have stored images or video recordings of that same building entrance, and that provided photo can be further examined to provide an authentication. Those images or video recordings may be stored within database 108, which can be queried for its content. In addition, those images may be provided through an API such as the APIs of GOOGLE MAPS, a mapping and turn-by-turn direction application provided by Google, a subsidiary of Alphabet Inc., which feature street images that correspond to correct addresses, which may also be mined for authentication purposes. This functionality may be useful in the case of employee module 434 having communication problems with one or more servers 102, or problems otherwise maintaining a stable connection. In such a case, this may provide a way to compensate for certain technological failings of connection networks.

Employee application 418 may additionally allow the employee access to a web portal or other means of data input and/or system access. In the event a client cannot sign for a service, the system may depend on the employee to collect information to confirm or verify the work request, such as a fingerprint, voice confirmation, or verification information from the client via employee module 434. A manager may use manager module 432, which is in communication with one or more servers 102, to access the system. Manager module 432 may include manager application 412, and may integrate manager computing device 414 to implement manager application 412. One of ordinary skill in the art will appreciate, however, that manager application 412 may be programmed to differ from employee application 402 or employee application 418. Manager computing device 414 may also give a manager access to manager module 432 through manager web portal 416. Manager module 432 may be configured to send a work request to one or more servers 102 or one or more processing units 104. This work request may be then transmitted to employee module 430 or employee module 434.

In certain embodiments, a client may use client module 436 to access certain system functionalities. A client application 424 may be run on client computing device 426. Client module 436 may also include geolocation identifier 408, camera 422, and clock mechanism 410, among others. According to an exemplary embodiment of the invention, some functionalities may be achieved by providing a client module. The client may use the client module, which may be in communication with one or more servers while allowing the client to contact a relevant manager or other party associated with a company. The client module may include an application, and the application may be cross-platformed to allow the client to use the functionalities of a mobile device such as a smartphone, smartwatch, tablet, or other computing devices such as laptops or PCs. The application may also provide the client with means to access client module 436, where the client may access past route information, profile information, medical information, etc. The client may also use client module 436 to transmit confirmation information confirming completion of the work request by the employee, specific aspects or segments of the work request, and/or particular routes utilized to travel between two locations associated with the work request. This information may include, for example, a signature, a PIN, a passcode, a fingerprint, biometric data, a timestamp and/or location data.

It is to be understood that while employee module 430, 434, manager module 432, and client module 436 may include similar elements (such as a specific application or may contain elements such as geolocation identifier 408, camera 422, clock mechanism 410, etc.), these elements need not be identically implemented within each module. Geolocation identifier 408 and clock mechanism 410 may be used to, respectively, ascertain the location of system activity, in addition to obtaining a timestamp for that system activity on employee module 430, manager module 432, client module 436, or employee module 434. This may be of use in potential audits or as a security measure in some cases, especially if either module is being used on a mobile computing device.

One or more servers 102 may also provide access to user engagement panel 314, which may be accessed by a user through one or more modules connecting to user engagement panel 314 through network 124. User engagement panel 314 may be a user interface (UI) element. One or more servers 102 may access database 108 or one or more databases and display relevant data within it on the user engagement panel 314. One or more servers 102 may access all information regarding a certain work request and display it. User engagement panel 314 may be provided through such means as an online forum, message board, or other type of website that allows for the online discussion of relevant topics. User engagement panel 314 may be accessed on a web browser or provided as part of a user's application or as its own application that can be run on one or more computing devices. The data on user engagement panel 314 may be accessed generally, though it potentially may be redacted for private information depending on who may be viewing it. In other instances, it may be presented in whole to certain users, such as the user the information regards.

An employee may access user engagement panel 314 through employee module 434, where the employee can upload a photograph, submit reasons he/she was not within a field of acceptability, etc (further discussed below). On user engagement panel 314, photographs that an employee has uploaded may be displayed, and those photographs may include metadata with geotag information or a time stamp associated with the time the photograph was taken as well as metadata linking the photograph or other evidence to the computing device from which it was generated. For example, a digital image may include metadata that describes the means of creation of the data (e.g., the mobile phone or computing device which generated the digital image), the time and date of its creation, the creator or author of the data, the location where the data was created (e.g., the specific computing device, where on a computer network, etc.), the file size, how large the picture is, the color depth, the image resolution, the shutter speed, and other data. User engagement panel 314 can also be accessed through employee module 430 and manager module 432, where a user may access information for verification.

The systems and methods disclosed herein may also be used in conjunction with the systems and methods disclosed in U.S. patent application Ser. No. 15/474,685, filed Mar. 30, 2017, entitled “System and Method for Geo-Aware Transportation Billing Verification,” as well as U.S. patent application Ser. No. 15/934,677, filed Mar. 23, 2018, entitled “System and Method For Healthcare Billing Verification”, the disclosures of which are hereby incorporated by reference herein in their entireties. If a work request falls outside of a predetermined field of acceptability (further discussed below), then an alert may be sent to a manager or supervisory employee, and/or an inquiry may be opened to investigate the reasons for such deviation. In this manner, accountants and payroll clerks can save valuable time, employees do not have to risk having their wages reduced or docked, and managers know that work requests they booked were completed in good faith and on schedule.

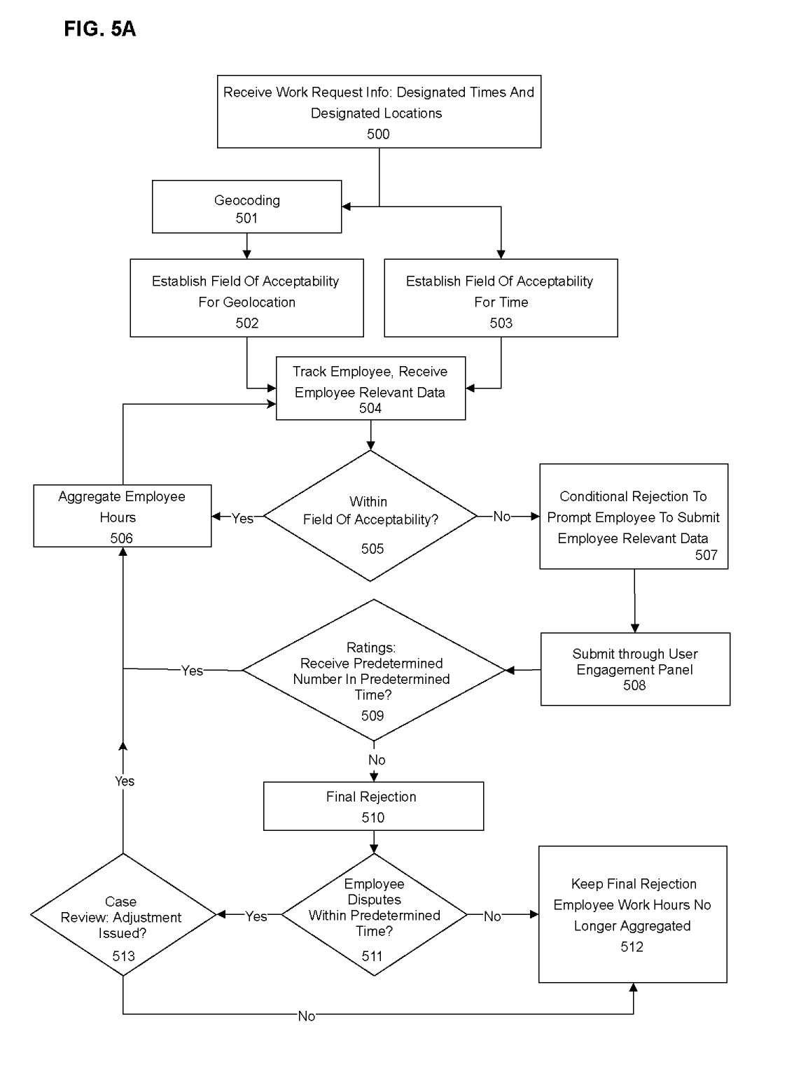

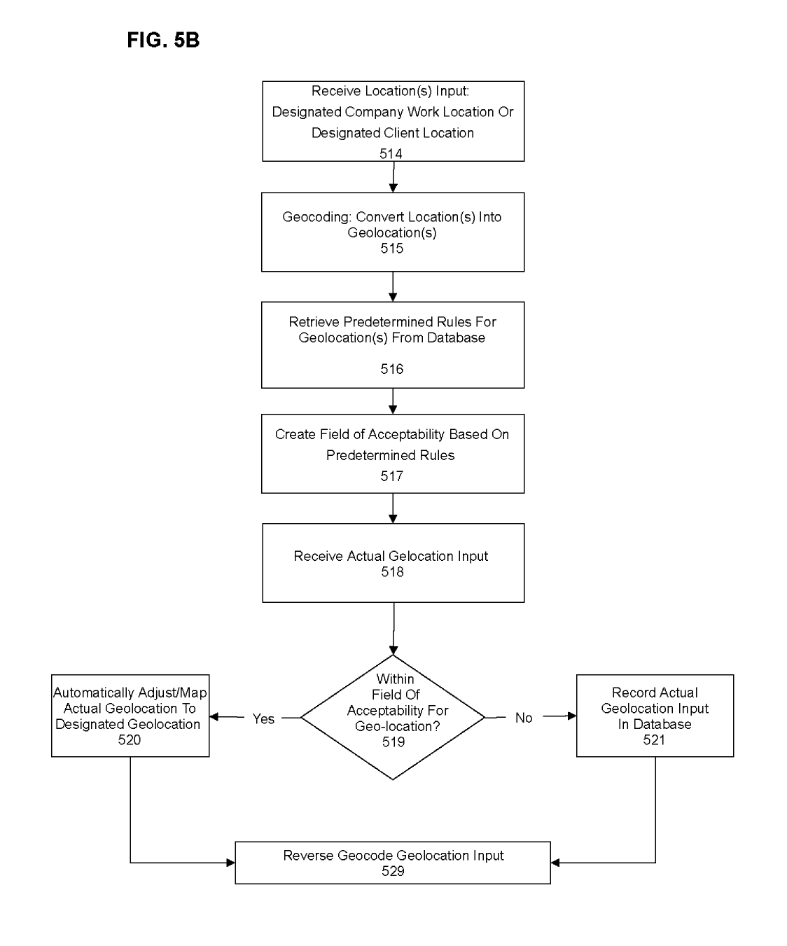

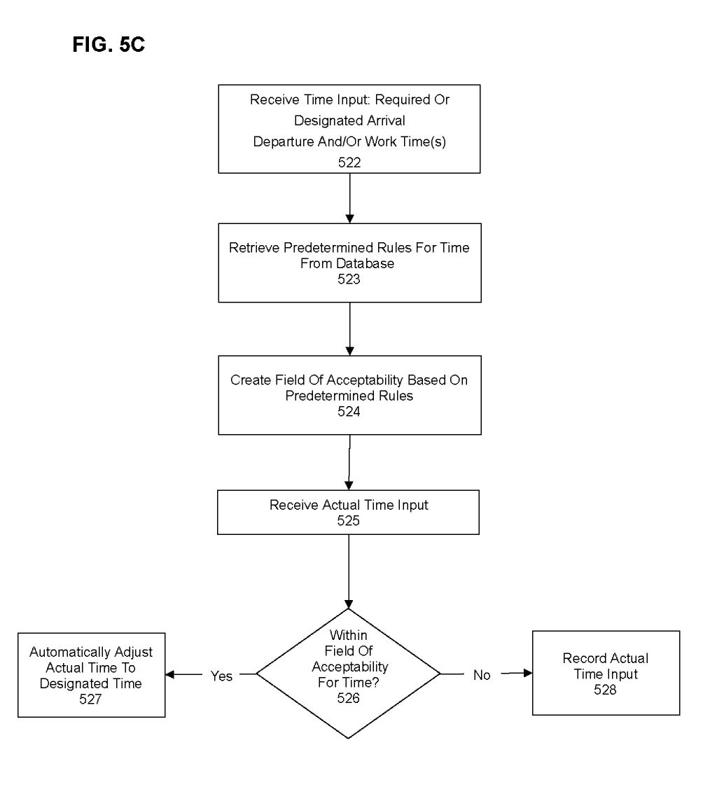

Referring now to FIG. 5A, shown is a flowchart illustrating an exemplary workflow for continuously tracking employee hours based on the employee's current work or service at one or more remote locations in accordance with an exemplary embodiment of the invention. The first step in the process is to receive a work request information (Step 500) by, for example, a company manager or supervisor, or by a client of the company. The work request may include designated locations and designated times where work is needed. A GIS or one or more servers may implement geoprocessing (Step 501), including geocoding a location input as an address into a geolocation, including, for example, longitude and latitude coordinates. This may be achieved using a third-party geocoding API such as GOOGLE MAPS. Based in part on the information submitted in the work request, one or more servers 100 can then establish a field of acceptability based on location, time, or location and time, which may be based on dynamically adjusted predetermined rules, using values inputted or included in the work request. Geocoding in part allows for the field of acceptability for geolocation(s) to be established (Step 502), by turning one or more locations into geolocation(s). In addition, a field of acceptability for time can be established (Step 503) based in part on the work request input. Once one or both or any other relevant field of acceptability has been established and the work request is underway, the system may track the locations of one or more employees over time, and may receive employee relevant data (Step 504). Employee relevant data may be transmitted or otherwise received periodically upon the occurrence of an event (e.g., the employee and/or client stopping for a certain amount of time or stopping within a certain distance of a designated location), or upon an information request (e.g., a manager, client, or other system monitor requesting a status update).

The geolocations of an employee may be recorded directly in reference to a map, which may be provided by a third-party API such as GOOGLE MAPS, a mapping and turn-by-turn direction application provided by Google®, a subsidiary of Alphabet Inc., which features street maps that show corresponding addresses and business names, which may be mined for authentication purposes. A map-based geolocation recording may be used to determine whether the employee was at an “acceptable” location, or somewhere which may warrant further review, such as a casino. It will be appreciated that a review at a later time may categorize a location as acceptable even though it was previously deemed unacceptable. For example, a particular client may enjoy going to a nearby casino, in which case an employee who does sales may take the client to the nearby casino to discuss business over dinner.

Based on the work request information and location(s), it can then be determined whether the employee is/was within the field of acceptability (Step 505), and the impact this may have on the employee's work hours. If the tracked information is within the field of acceptability or matches the work request information, then the system determines compliance, and the employee's work hours on the service request may continue to be aggregated (Step 506), and the system continues to track the employee (Step 504) and determine whether the employee is within the field of acceptability (Step 505). If at any time an employee is not within the field of acceptability, then the system determines noncompliance, and may issue a conditional rejection to prompt the employee to submit employee relevant data and/or get back within the field of acceptability for location and/or time (Step 507). For example, if the employee is at a location outside of a field of geolocations deemed acceptable for the work request based on predetermined rules and/or pre-set configurations (or within an authorized location but at an unauthorized time), then an indicator may be displayed on the employee's device 132 indicating that the employee is outside the field of acceptability associated with the work request. The employee may be prompted to submit work related data explaining why the employee is outside the field of acceptability. In this situation, verification may be needed as to whether the work request is being carried out or was completed. For example, the system may prompt the employee to provide one or more reasons and photo(s) for failing to be within the field of acceptability (Step 507). Such information may be provided through, for example, the user engagement panel of the employee's device 132 (Step 508). The reason may be, for example, a description of circumstances which prevented the employee from arriving at a designated time or a designated location, a description of why the employee went to a new location outside the field of acceptability (e.g., at the request of the client or manager and/or out of necessity due to, for example, closure of a building or road for construction). The employee may be prompted to submit a photograph enriched with time and geolocation data as proof. In certain embodiments, a client or company supervisor may similarly submit his/her own approval/authorization of the new location or service provided/needed in order to help verify the employee's new location or route thereto.

In certain embodiments, when the work related data is submitted via the user engagement panel, one or more additional users having firsthand experience may rate it. If the submitted work related data receives a predetermined number of ratings within a predetermined time (Step 509), then the employee's time may be approved, and his/her hours will continue being aggregated (Step 506) because the ratings have proven the employee related data to be accurate. The ratings may be positive ratings, negative ratings, ratings of confirmation, or any other rating type that conveys whether the one or more reasons provided are legitimate or accurate. If the information does not reach the predetermined number of ratings within the predetermined time (Step 509), then a final rejection (Step 510) may be issued. If the employee does not dispute the rejection within a predetermined time (No, Step 511), then the final rejection may be maintained (Step 512), and the employee's work hours will no longer be aggregated for the work request.

If the employee believes his/her claim is legitimate, and so indicates within a predetermined time period (Yes, Step 511), then a company manager, supervisor, or administrator (CSA) may open a case review. In a case review, the CSA may review the reason(s), photograph(s), and/or other information the employee submitted. If the CSA does not believe an employee's claim is legitimate and does not approve (No, Step 513), then the rejection is kept final and the employee's work hours are not aggregated for time purportedly spent on the work request when the employee was outside the field of acceptability (Step 512). If the CSA approves (Yes, Step 513), then the employee's time may be approved, and his/her hours previously deemed outside the field of acceptability will be aggregated into the employee's total work-time spent on the work request (Step 506). Employee relevant data submitted may include, for example, parking restrictions, road rules, constructions sites, temporary road blocks, changes in client desires/needs, temporary and permanent service location closures, new service location options, etc. Road closures for special security events, parades, rallies, or protests may also make it impractical or impossible to arrive at the right location. Such circumstances may be disclosed by the employee as reasons for any location or time discrepancies.

In certain embodiments, determinations by the CSA may be based on information collected from a client or company manager and used in conjunction with the employee module information or on its own. In certain embodiments, when an employee is not within one or more fields of acceptability, a conditional rejection or final rejection may ultimately lead to a reduction in work hours of the employee for payroll and/or overtime calculation purposes.

It will be appreciated that the system will continually aggregate the employee's work-time spent on the service request in accordance with predetermined rules for all time periods during which the employee is deemed within the field of acceptability (either in real time or following a subsequent approval by a manager after the employee has submitted the employee relevant data and/or disputed a final rejection). Similarly, the system will not aggregate the employee's work-time spent on the service request in accordance with predetermine rules for all time periods during which the employee is deemed by the system to not be within the field of acceptability, provided such determinations are not later overruled following an employee dispute, if any. The predetermined rules may determine, for example, whether the field of acceptability includes routes to and from designated locations, buffer tolerances with respect to time and location, etc. The field may be configured as aggregate data comprising at least one of one or more location data sets corresponding to the one or more designated locations or one or more time-location data sets corresponding to the one or more designated times and the one or more designated locations. In certain embodiments, the system may enable an employee to gain work-time credit on a work request when the employee travels from his/her residence to a remote work location or remote client location, or from the remote work location or client location to the employee's residence or to the employee's normal work location. In other embodiments, the start button functionality discussed above with respect to computing device 128 may be utilized by the employee to indicate to the system when he/she believes to have begun work on the work request (e.g. upon departing his/her residence or office location, or upon arrival to the designated location, depending on how employee hours are aggregated in accordance with predetermined rules).

FIG. 5B shows a flowchart illustrating an approach for mapping/adjusting an actual geolocation to a designated company work location or a designated client location when the geolocation is deemed within a field of acceptability of the designated location, in accordance with an exemplary embodiment of the invention. At Step 514, one or more servers receive location inputs that may contain one or more designated work locations (e.g., company locations and/or client locations). Each of these locations is geocoded (e.g., the input locations are converted to geolocations) (Step 515). The geolocations may be used to retrieve one or more sets of predetermined rules associated with those particular geolocations from the database (Step 516). For example, based on a geolocation corresponding to a designated work location, predetermined rules for the field of acceptability are retrieved, and the system may determine, based on the predetermined rules, that the field of acceptability is area within, one hundred and twenty (120) feet of the designated geolocation. It will be appreciated that other distances may be utilized.

For the field of acceptability assigned to a geolocation, the predetermined rules may create the dimensions of a “buffer,” which are what allow a GIS, such as ArcGIS® (e.g., a mapping platform provided by Esri®—a provider of spatial analysis software), and/or one or more servers to create the field of acceptability. The buffer establishes an area based on a center point which includes all points that qualify as acceptable based on the predetermined rules, and using the buffer, the field of acceptability can be created. In an exemplary embodiment of the invention, that center point may be moveable or fixed. With spatial analysis software, certain coordinates with certain attributes may be grouped together within a buffer. The buffer may be based on a set geolocation coordinates. The buffer may then be configured to contain all coordinates within a certain distance of one or more center points (e.g., one or more designated location) as its parameters. As long as the employee is within this field of acceptability, and the tracked geolocation is determined to be a qualified geolocation or route, then the employee's geolocation may be automatically adjusted to reflect that of the designated geolocation, and stored as such in database 108. In this manner, in certain embodiments, future identification of the same geolocation during performance of a work request by the employee for the same designated location may automatically be deemed compliant without calculation, thus saving system steps and improving processing speed.

The buffer may establish the field of acceptability by establishing an area which includes all points qualifying as acceptable based on the predetermined rules (Step 517). With spatial analysis software, certain coordinates with certain attributes may be grouped together within a buffer, which may be based on a central set of coordinates converted from an input work request address during geoprocessing. The buffer then is configured to contain all coordinates within a certain distance of the center point as its parameters. The coordinates associated with the geolocations all meet certain criteria, and therefore, may be grouped based on that similarity.

Once the field of acceptability has been established, actual geolocations associated with the employee (and corresponding times) may be received by one or more servers 100 (Step 518). Based on this input, the system can determine (e.g., continuously or periodically) whether the actual geolocation(s) is/are within the field of acceptability (Step 519) and is/are therefore “qualified geolocation(s)”. If so, then the system may make an automatic adjustment for and/or map the geolocation to the designated location (Step 520). For example, a field of acceptability may be established based on a predetermined rule which calls for a size of 300 feet, where the center coordinates for the field of acceptability are based on a designated geolocation of 40° 45′23.2″N, 73° 58′35.8″W. If the employee were to visit a client at 40° 45′23.6″N, 73° 58′35.0″W, which is 105 feet away from the designated location, then the one or more servers may automatically select the designated input for the geolocation, which is 40° 45′23.2″N, 73° 58′35.8″W, rather than the actual input. Similarly, in an example where an employee is asked by a client to travel to a different geolocation, once the system detects that the employee is no longer within the field of acceptability, the employee may provide evidence that the new geolocation should be an approved geolocation for the work request. The system may then adjust the geo-location for the new location to the designated geo-location of the work request. In this manner, future trips by the employee to the “new” location(s) will automatically be re-designated or adjusted back to the designated geo-location so the system automatically recognizes that the employee is not outside the field of acceptability, and prevents discrepancies or unnecessary data processing during generation, analysis, and approval of employee work time, payment, and overtime. Such automatic adjustments or re-designations reduce the necessary data processing of the system during the tracking and payment aspects of the invention.

In other exemplary embodiments, the field of acceptability may be based on a programmed “snap tolerance,” such as in a GIS, where locations may be “snapped” into groups on a map. The determination of whether the geolocation is within the field of acceptability may, in addition to a coordinate-based analysis, be done by determining a distance between two input points, such as feet, meters, or other measurement. In some exemplary embodiments, geolocations can be geocoded back into human-readable addresses (Step 529). If the actual geolocation is not in the field of acceptability, then no automatic adjustment for geolocation is issued, and the actual geolocation input is recorded by system 100 in database 108 (Step 521). Geolocation input may be geo-processed back into a human readable address (Step 529). Thus, the actual geolocation may be geo-processed back into the actual location.

The field of acceptability may be previously established (e.g., predetermined) based on a default setting. The default setting may depend on the area, the time of day, etc. The predetermined rules that define the field of acceptability may also be subject to variation. For example, a field of acceptability based on distance may not need to be based on a particular radius for an entire three hundred and sixty degree (360°) sweep about a center location, and may instead be a region (e.g., horseshoe shaped) of uniform or non-uniform dimensions. In another embodiment, the field of acceptability may be based on a geo-fenced area with multiple sides of varying length, height, or any other dimension or parameter. It will be appreciated by one of ordinary skill in the art that in some embodiments such regions may be set through adjustments to the field of acceptability. These adjustments may then further be made more accurately by dynamic updates to the predetermined rules. Alternatively, the system and method may further comprise establishing a set of service rules that define and/or redefine the field of acceptability, and may include rules that establish a predefined region for the work/service location, one or more locations not within the predefined region for the service location, the service time, and a time period which includes the service time. Upon identifying compliance with the work request, the system and method may modify the set of work/service rules to include the location data generated by the first computing device in defining and/or redefining the field of acceptability.

The field of acceptability sizing may vary based on a location. For example, a field of acceptability may include a larger area in a densely populated urban setting in a smaller city because taller buildings may cause signal disruption or other technological limitations. Local and nearby Wi-Fi connections may be utilized to aid in geolocation, particularly where GPS signals are inadequate. A GPS error amount may also be calculated, and the error associated with a signal or at a different area may be factored into the GPS output or received input. The error amount may be different from location to location to compensate for interference or poor quality of signal.

Referring now to FIG. 5C, shown is a flowchart illustrating an exemplary workflow for adjusting a designated time corresponding to an employee arrival or departure to an actual time of the employee's arrival or departure when the actual time is deemed within the field of acceptability in accordance with an exemplary embodiment of the invention. Once a work request has been submitted by a manager, client, or other relevant party, the required or designated time input is received (Step 522) by one or more servers. Based on the work request, system 100 may determine whether there are predetermined rules for the field of acceptability based on time by retrieving information from database 108 (Step 523). System 100 may reference a unique ID number or another work request identifier that can be used to query the database for the relevant information. Once the designated time/location and the predetermined rules regarding the field of acceptability based on time for a work request are retrieved, the field of acceptability based on those predetermined rules may be established (Step 524). The field of acceptability based on time may cause times to be grouped by attribute, in which case the defined attribute may be based on a predetermined time or other temporal constraint. Next, the work request can be carried out and the actual time input can be received from the employee module (Step 525).

Based on the actual time received, the system can determine whether the employee is within the field of acceptability for time (Step 526). The designated time will be a known time value, used as a point of comparison, to the actual time, where the rule may dictate that any time outside of a time window will not be an acceptable or qualified time, and therefore rejected. The rule may dictate what is a qualified time, such as any time input that is within 10 minutes of the designated time. For example, if the designated time is 9:15 AM, and a rule dictates that only times within 10 minutes constitute a qualified time, then one or more servers 100 or other means of processing may accept any time input between 9:05 AM and 9:25 AM. In other exemplary embodiments, the field of acceptability for time may be created by a rule which makes a qualified time 5 minutes before the designated time while simultaneously creating a field of acceptability that is 10 minutes after. This may mean that a qualified time in this exemplary embodiment may be, for a designated time of 9:15 AM, between 9:10 AM and 9:25 AM. A comparison may be made on the basis of a logical function that creates a timeframe, which may be provided and written through a programming language to be carried out by a computing device. If the time input is within the field of acceptability, then an automatic adjustment for time input may be issued (Step 527).

Adjusting a payment request with regard to time may be done programmatically and automatically according to one or more rules which may be adjusted programmatically or manually after review by an employee. If the time is not a qualified time, then no automatic adjustment for time will be allowed (Step 528), but the actual time input may still be recorded in database 108.

For a field of acceptability based on time, a designated time may be a known time value or period for when and/or for how long work may be scheduled. The designated time may give context to a predetermined rule which defines a “qualified time.” For example, a qualified time input may be within 10 minutes of a designated start time of 9:15 AM, and a predetermined rule that allows times within 10 minutes before and after the designated start time as qualified times. A comparison may be made on the basis of a logical function that creates a timeframe, which may be provided and written through a programming language to be carried out by a computing device. Accordingly, one or more servers or other means of processing may accept any time input between 9:05 AM and 9:25 AM. Any time input between this 10-minute range is considered a qualified time as it is within the field of acceptability. The actual time may be adjusted to the designated time. If an employee arrives at 9:17 AM, the time input may be adjusted to 9:15 AM and/or recorded as 9:17 AM but considered a qualified time. Adjusting actual time to designated time may be done programmatically according to a rule or may be adjusted programmatically or manually after review by an agency. If the time is not a qualified time, it will not be adjusted automatically. Instead, the actual time input will be recorded, and the employee may provide reasons for the discrepancy, as described in more detail below.

It will be understood that FIGS. 5B-5C may be instantiated as subroutines which are intended to describe more specific steps regarding establishing fields of acceptability as mentioned in FIG. 5A, rather than figures that establish the only process by which one or more fields of acceptability may be established. The field of acceptability may relate to the employee traveling a total distance, traveling along a certain route, travelling to specific authorized locations, staying with or near the client, obeying traffic rules, adherence to work requirements, etc. The predetermined rules may also be subject to change based on collected data, which in some exemplary embodiments may be analyzed by artificial intelligence (AI). AI may determine patterns which may subject the field of acceptability to change in certain conditions. For example, weather conditions may affect the ability of employees to timely arrive at some locations and/or increase traffic congestion. In such situations, AI may change the field of acceptability based on predetermined rules.

It will be understood by one of ordinary skill in the art that an approach to changing the field of acceptability based on data collection may be applied to numerous other factors not limited to weather conditions. Furthermore, the field of acceptability based on distance does not need to be based on a certain radius. However, to qualify for work hours/time, the employee must meet all or a certain number of variables. For example, to qualify for work time, an employee must provide service as requested, or otherwise have his/her work hours adjusted following a dispute. However, cases may arise where an adjustment is or is not made to such one or more variables even though the employee ultimately provided the services of the work request. For example, if an employee does not have legitimate reasons for picking up or taking out a client at a location different from the designated pickup or visit location, but still visits with the client and/or provides service within other correct or designated time periods, then the one or more reasons for the employee not making a pickup at the correct location may be collected and analyzed. However, as the work request was satisfied, the employee may or may not be entitled to his/her work hours associated with the work request (e.g., in full, in part, or not at all) depending on the particular scenario and management's discretionary determination.

Situations may arise in which an employee does not participate as expected, or where one party is unable to locate the other (e.g., a no-show or an attempt to meet at a crowded location). If the employee does not show up for a scheduled work request, then no work/service has been provided and the employee will not accrue work time for that work request. If, on the other hand, the client does not show up, then there may be no verification from the client. There may also be situations when the employee or client cancels the work request before or during the service.

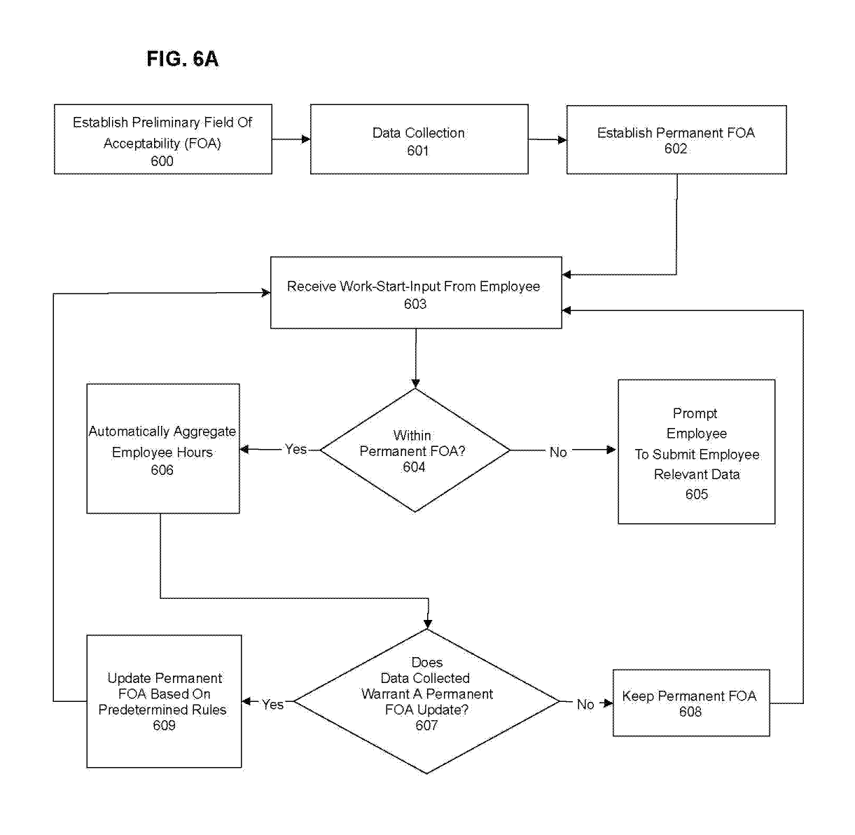

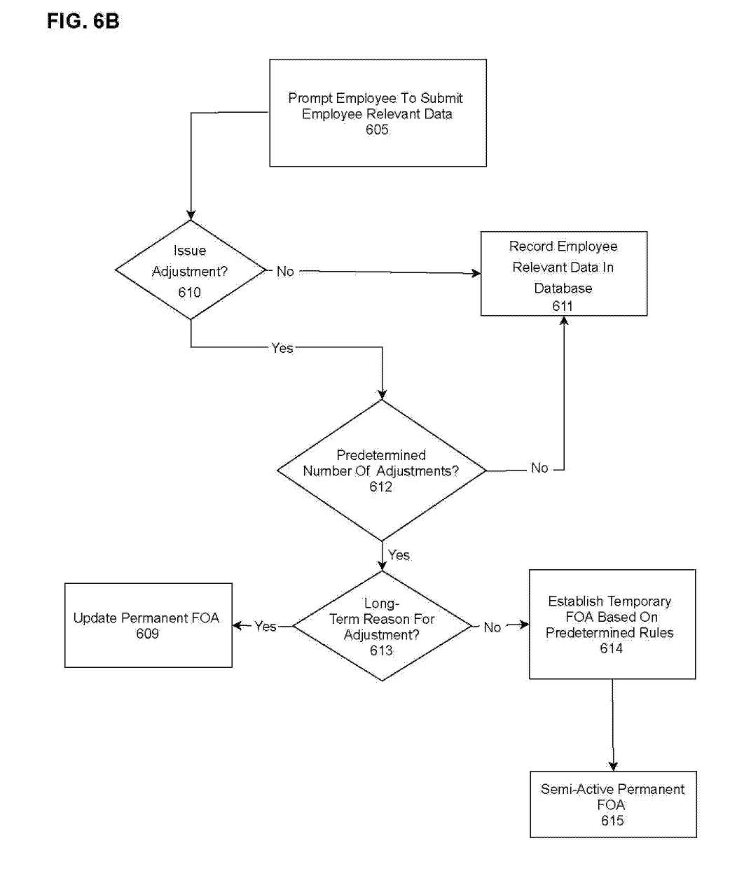

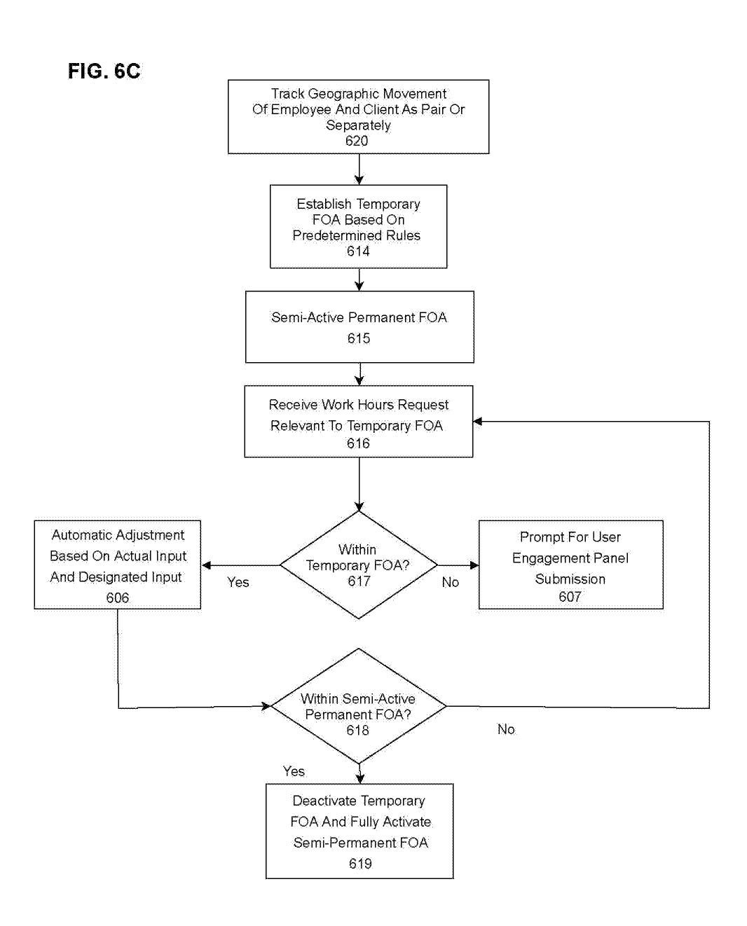

Turning next to FIG. 6A, depicted is a flowchart illustrating an approach for establishing and updating a field of acceptability in accordance with exemplary embodiments of the invention. In certain embodiments, the company or entity which bears responsibility for paying the employee or independent contractor may be given the authority to establish an initial (preliminary/temporary) field of acceptability, and to authorize temporary or permanent updates thereto. The method of establishing the field of acceptability may include different stages during which the parameters of the field of acceptability differ. In certain embodiments, three “types” of fields of acceptability may apply. The field of acceptability may first be established as a preliminary field of acceptability based on a manager's discretion or common sense, arbitrarily, or based on historical data and/or an individual company's mandates, guidelines, and rules for service, if available. A preliminary field of acceptability may thus be established based on default parameters, automatically or manually (Step 600). Such default parameters may be predefined by a manager, a manager's agent, the company, or another relevant party, agency, or company (e.g., a parent company). Default parameters may be arbitrary but updated in response to how employee services are provided. System 100 may employ significant data collection (Step 601), during a predetermined number of work requests, and/or with a same location or a plurality of locations close to one another. During this phase, user engagement panel 314 may be employed to collect information or data which may help in eventually transforming the preliminary field of acceptability to a more accurate permanent field of acceptability. Data collection may help establish a more accurate permanent field of acceptability, and the collection process may take place for any length of time, as necessary. Data collected may be stored in database 108. However, “permanent” as used herein with regard to the field of acceptability does not indicate that the field cannot or will not be changed. The term “permanent” is used herein with respect to “field of acceptability” to indicate that it may be applicable over a longer period of time. There may be circumstances where the permanent field of acceptability is subject to change based on collected data or reset, such as a permanent street closure, a change in rules or regulations, or by the employee and client travelling to new locations which the client (and ultimately the company) approve.

The default parameters of the preliminary field of acceptability may be generally based on services provided previously until they are updated to reflect the services more clearly. Updates to the default parameters may cause the field of acceptability to expand or to shrink for improved accuracy. If certain circumstances call for a field of acceptability to be reset, then an additional data collection period may occur again. In certain embodiments, the data gathered during this data collection period may change a preliminary field of acceptability to a permanent field of acceptability.

Sometimes it is impossible for an employee to be within the same vicinity as a client. Client and employee tracking may thus be configured to accommodate this concern, and the field of acceptability may similarly allow flexibility for such separation between the remote computing devices of the client and employee, which preferably remain on their persons or very closely near them during the entire time of the employee's service. As tracking may require the employee to “clock in” at certain time intervals, a company may provide a grace period for the input intervals (e.g., a set number of minutes before and after each prompt is communicated to the employee). During this period, if the employee (and optionally the client) both input their information, then the employee will be deemed compliant.

The field of acceptability, the predetermined rules, and/or a set of service rules may be updated dynamically in accordance with aggregated employee relevant data. The aggregated employee relevant data may include GPS data corresponding to one or more geolocations and time data corresponding to one or more times or days of transmission of the aggregated employee relevant data. For example, the system may receive aggregate data for a plurality of work requests for a client at a central location (e.g., a client's office or building location serviced by one or more employees), and used to adjust a field of acceptability around the central location (e.g., a pre-set distance may be too large or too small for the location). If location data associated with the employees reveals that employees stay within 50 feet of a location (e.g., the client's office building) 90% of the time, then the predetermined rule for establishing the service field about the office building could be 50 feet. However, if 90% of employees complete service while staying within 20 feet, then the acceptable service field may be automatically reduced after completion of a preset number of work requests. Other percentages, such as 50%, 75%, 80%, etc. may be utilized as the threshold for changing or adjusting the field, and other distances (e.g., 20 feet, 25 feet, 30 feet, 40 feet, a block, a mile, etc.) may be utilized as a distance to set from the central location.

As discussed herein, the field of acceptability can take any number of forms, can encompass many locations and routes, and is not limited to a radius, circle, or any other particular geometric shape. In this manner, aggregate data may be used to update the field. If a number of adjusted locations or times supported by the same type of legitimate reasons reaches a predetermined number, then the preliminary field of acceptability may be deactivated and transformed to a permanent field of acceptability. Generally, if the data collection shows employees repeatedly outside the preliminary field of acceptability, then the preliminary field of acceptability may be deactivated, modified, and/or transformed into a larger permanent field of acceptability based on relevant data collected. If, on the other hand, the data collection shows that employees repeatedly are most often closer to the designated location than the maximum distance established by the preliminary field of acceptability, then the preliminary field of acceptability may be transformed or modified into a smaller permanent field of acceptability. In this manner, based on data gathered during data collection, the permanent field of acceptability is established (Step 602), and represents a more accurate reflection of when or where employees are working and/or providing services. Since real-life situations often change and may affect the location(s) where services are provided, the field of acceptability may need to be repeatedly updated.

Preferably, only one maximum field of acceptability exists at any given time but can apply to an array of locations. The status of the field may change in accordance with company and/or client needs and the types of service(s) or work the employee provides. Each field of acceptability contains three characteristics, namely, fully-active, semi-active, and non-active. System 100 may employ continuous data collection to maintain the accuracy of each field characteristic. Additionally, continuous data collection can aid the company to keep track of particular employee and client travel patterns.

In certain embodiments, the preliminary field of acceptability may be based on an employee's initial visit or by the company. The preliminary field set-up may utilize historical data. A CSA may initially decide what area range (e.g., region) outside a company's designated work location (e.g., for smoke breaks, etc.) or outside a client's office or workplace (e.g., for travel to lunch) is reasonable. Eventually, this range dictates initialization of the preliminary field automatically by the system. Alternatively, the system may automatically generate the preliminary field based on pre-set distances and ranges for a given location within a given geographic area. Historic data may include stored histories for a plurality of employees proximate to that location and assign a reasonable range.

In certain embodiments, after sufficient data is collected from a service visit, the data may be sent to a CSA for analysis and review. Upon review completion, the CSA decides whether the data is reasonably sufficient to deem the location a permanent field of acceptability. Occasionally, exigent circumstances such as emergencies or any other necessities may arise which require an employee to travel outside of the permanent field of acceptability. Such circumstances may temporarily change the field of acceptability for a limited time.

In certain embodiments, system 100 receives a work-start input from an employee (Step 603), and determines whether the employee is within the permanent field of acceptability (Step 604). For example, an employee may push a start button input on his/her computing device 132 to indicate he/she is about to start travelling to a designated work location. If the employee is not deemed within the field of acceptability (or deviates from the field for a requisite period of time) (No, Step 604), then a conditional rejection may be issued as described above, and the employee may be prompted to submit employee relevant data in the form of one or more reasons or photographs through a user-engagement panel (Step 605). As disclosed with respect to FIG. 5A, employee work hours may be subject to a full or conditional rejection depending on the circumstances. In certain embodiments, an employee may be given the option to upload evidence even in the absence of a real-time alert or rejection so that the information is already in the system in the event of a dispute. In yet other embodiments, if the employee is unaware that he/she is outside of the field of acceptability, then time sheets and/or client or company manager certifications/authorizations may be utilized to prove compliance with the work request.

If the employee is determined to have been within the field of acceptability, then the employee's work hours are automatically aggregated (Step 606). Based on predetermined rules, the system may determine whether the data collected (from one or multiple employees) warrants an update to the permanent field of acceptability (Step 607). Such determinations may be accomplished by evaluating actual inputs (e.g., actual geolocations or actual times) compared to designated ones and maximum field allowances. By way of example, if for a designated geolocation, the field of acceptability accepts an input within 100 feet, then 100 feet is deemed the “maximum allowable input.” If the provision of service repeatedly occurs at only 25 feet from the designated location, then this may be considered evidence that the field of acceptability is too permissive. If the actual inputs are not substantially different (No, Step 607), then the data collected would not warrant an update to the permanent field of acceptability (Step 608). If the data collected does warrant an update to the permanent field of acceptability (Yes, Step 607), then this may cause such an update based on predetermined rules (Step 609). The update may tailor the field of acceptability to the relevant size based on the employee relevant data (e.g., the field of acceptability may be made smaller or expanded to be more permissive). If an employee is not within the field of acceptability, then he/she may be prompted to submit the reason(s) on user engagement panel 314 as discussed above.

In certain embodiments, if a predetermined number of employees provide the same or similar reasons through the user engagement panel, then a temporary field of acceptability may also become a permanent field of acceptability similar to the process of a preliminary to permanent field. This determination may also be based on how long the temporary field of acceptability has been in place. It will be understood that the terms preliminary, temporary, and permanent as used herein are terms intended to explain different stages of establishing and updating a field of acceptability, and that these terms are not intended to be the only definitions or descriptions of the ideas they convey. In certain embodiments, system 100 may also periodically issue an alert to the employee to notify him/her of being within the field of acceptability so the employee does not need to guess or worry about future disputes over work time hours. The employee preferably receives an alert or alerts (with or without indicators) notifying him/her of being outside the field of acceptability as discussed above. Such alert(s) may indicate that the employee needs to proceed closer to a designated location in order to be authorized, or to submit evidence/authentications of new locations or routes.

Referring to FIG. 6B shown is a flowchart illustrating an approach for establishing a temporary field of acceptability in certain circumstances. If, for example, an employee is asked by a client to drive him/her to a new location outside the permanent field of acceptability (e.g., travel to a new or secondary client location not already within the permanent field), then the employee may be prompted to submit employee relevant data (Step 605) so that the system can determine whether adjustments have or need to be made (Step 610). Such decision may rely on, for example, a confirmation from the client and/or company manager. If an adjustment is ultimately issued (Yes, Step 610), then system 100 may next determine whether a predetermined number of substantially similar adjustments have been made for the same client (e.g., based on the location, based on the reason, etc.) (Step 612). If an adjustment is not issued (No, Step 610), then the employee relevant data 605 is simply recorded and stored in database 108 for potential later use (Step 611). If a predetermined number of adjustments have been made (Yes, Step 612), then system 100 may analyze the reason(s) for the adjustment and whether the reason(s) is/are long-term ones (Step 613). If the reason is determined to be long-term (Yes, Step 613), then the temporary field of acceptability may be updated to a permanent one based on predetermined rules (Step 609). If the reason is not long term (No, Step 613), then the temporary field of acceptability may be established based on predetermined rules (Step 614).

In certain embodiments, the temporary field of acceptability may be a semi-active field (Step 615), and be used to accommodate emergency situations which may be proven later by an employee's explanation for either not arriving to or travelling outside of the permanent field of acceptability. The employee may be given a timeframe and a request for an explanation through the user engagement panel as to why the employee and one or more clients are outside of the established permanent field of acceptability. If the reason provided by the employee is valid, then a temporary field of acceptability is created for a limited time duration.

According to an exemplary embodiment of the present invention, certain fields of acceptability may be in a state of activity such as active, inactive, or semi-active. An “active” field of acceptability herein is intended to refer to a field of acceptability that is currently applicable and applying to time or location in a payment request. An “inactive” field of acceptability may refer to a field of acceptability that has been deactivated because it is considered inaccurate. “Semi-active” may refer to a permanent field of acceptability that may be incorporated with a temporary field of acceptability, and fully activated to the permanent field when the temporary field is deactivated according to predetermined rules. Certain conditions may trigger full activation of the semi-active permanent field of acceptability as disclosed in FIG. 6C.

Referring to FIG. 6C, shown is a flowchart illustrating an approach for updating the temporary field of acceptability. When a temporary field of acceptability is established and in place (Step 614)(FIG. 6B), which may also or alternatively be a semi-active field (Step 615), an employee may submit a work hours request relevant to the established temporary field (Step 616). System 100 determines whether the employee was within the temporary field for a requisite period of time (Step 617). If the employee was within the temporary field, then system 100 may make an adjustment to the employee's work hours based on an actual input and a designated input (Step 606). If the employee was not within the temporary field, then he/she is prompted to submit employee relevant data via user engagement panel 314 (Step 607) in support of an adjustment.

In certain embodiments, a series of conditions may cause the temporary field of acceptability, once established, to be deactivated. When an employee is determined to have been within a temporary field of acceptability and an adjustment is made (Step 606), system 100 may further determine whether the employee was within a semi-active permanent field of acceptability (Step 618). If the employee was within the semi-active permanent field of acceptability, this may be an indication that the temporary field of acceptability no longer applies. Such a scenario may trigger deactivation of the temporary field of acceptability and full activation of the semi-active permanent field of acceptability (Step 619). For example, the temporary field of acceptability may have been established because an employee was asked by a client to drive him/her to, for example, the airport, which may be within the semi-active permanent field of acceptability. If the employee was not within the semi-active permanent field of acceptability, yet was still within the temporary field of acceptability, then the temporary field of acceptability may still apply.

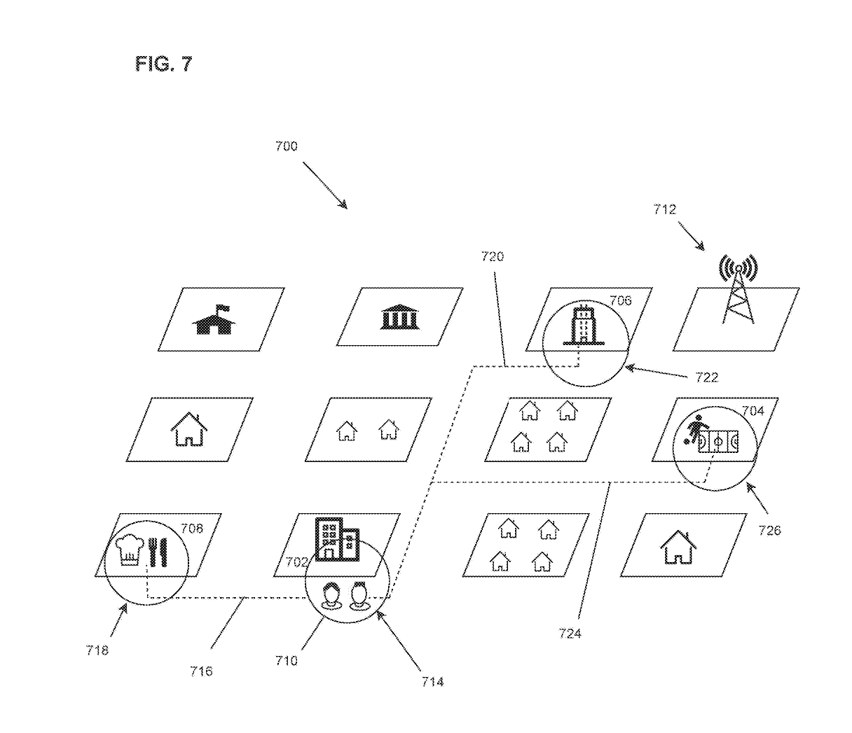

Turning next to FIG. 7, shown is a landscape 700 illustrating the application of the field of acceptability based on distance in accordance with exemplary embodiments of the invention, in which employee services are tracked accurately and conveniently. In particular, employee and client 710, shown at client's office 702, may have computing devices 130, 132 which may be a mobile telephone or smartphone, specifically configured to track services provided by the employee. Various other establishments may be located within the vicinity of the client's office 702, such as restaurant 708, sports arena 704, client's second facility 706 etc. As part of the service to be provided in accordance with the work request, the employee may be responsible for traveling to any one of these locations during the time frame they are with the client. Conversely, certain other establishments may be off-limits or otherwise not authorized for the employee to visit. Also, communication tower 712 is preferably in sufficient proximity to permit communication between system 100 and one or more computing devices 128. Computing devices 128 may be used to verify that the employee has worked with the client within the parameters of the work request, including verifying that the employee did not spend time outside of the required locations or routes thereto when rendering the services during the time frame(s) designated in the work request.

In certain embodiments, the client and employee are registered with system 100, and the client's address and schedule for service is stored in database 108. An employee can then be assigned to provide services for the client in accordance with, for example, work requests outlining the assigned appointments. Employee module 434 may interface with computing device 128 to add appointments to the employee's computing device 128. When the employee arrives at client office 702 pursuant to an assigned work request, the computing device 128 may transmit a signal to system 100 indicating that the employee is at client office 702. The system may periodically ping the location of computing device 128 to identify and record its location, for example, every few minutes until the employee manually indicates completion of the services, or if the detected location data indicates that the employee moves outside of the field of acceptability (i.e., by traveling away from client office 702 or away from other designated locations shown in FIG. 7 or routes thereto) or is at a time that is outside the time period for rendering such services.

Additionally, a vehicle (which may include an employee module) may be driven by an employee providing services pursuant to a work request with a primary designated location as the client's office 702. As established by certain predetermined rules and/or the work request, one or more fields of acceptability may be established for the employee to render services. For example, in one embodiment, a field of acceptability 714 may be established for the employee to render services at client office 702. In, for example, a home healthcare context, the employee (e.g., a caregiver) may be responsible for taking care of the client's laundry, and thus may need to travel to a laundromat on occasion. Accordingly, temporary fields of acceptability 718/726 including routes thereto from the client's office 702 may be established. If these locations are later confirmed as verified services to be provided pursuant to the work request (and verified locations), then temporary fields of acceptability 718/726 may be incorporated into or included in the field of acceptability 714 as a permanent field of acceptability. It will be appreciated that there may be more than one feasible route or path from one service location to another. In certain embodiments, each of the routes may be automatically included as part of temporary field of acceptability 726. Additionally, paths or routes over which the employee must travel will also be incorporated into the temporary field(s) of acceptability for the particular work request. Of course, the temporary field of acceptability will include at least both the time and location points of routes 716/724 from client office 702 to restaurant 708 or sports arena 704, respectively. So long as the employee does not deviate from the time and location parameters of the routes to restaurant 708 and/or sports arena 704, system 100 will consider the employee to still be within the field of acceptability.

In certain embodiments, if an employee traverses a new route between two approved locations which are already part of the field of acceptability, and the employee traverses the new route within a pre-set amount of time, then the system may automatically make/deem the new route part of the field of acceptability without any user input or administrator, client, or agency approval. In such circumstances, there may be no need for establishing a temporary service field for the route because the two service locations to which the route connects have already been approved, and the employee was able to traverse the new route within a reasonable time. It will be appreciated that the field of acceptability may be tailored to specific pathways along routes which employees travel, and that unapproved and/or rejected regions or locations may be bounded or circumscribed by approved routes or locations. For example, an unapproved location may fall between two or more approved locations/regions. Additionally, the field of acceptability around a particular location at an end of a route may be increased or decreased in accordance with aggregate data as described above.

In an exemplary embodiment of the invention, system 100 may enable verification of payment information associated with employees by automatically adjusting the location data or the time data generated by the first computing device to an approved time and location of the work request. In this manner, when the work request is billed, the system 100 does not need to compare data from multiple locations, thus reducing processing time. Additionally, if an employee is again detected to be at the same location during a time when he/she is caring for the same client, system 100 automatically recognizes the location as an approved location for the work request.

Continuing with respect to FIG. 7, the first time the employee travels to restaurant 708, system 100 may issue a notification to the employee that he/she is not within the field of acceptability for the client. Upon receipt of evidence (i.e., from the employee or client) that the employee must travel to restaurant 708 as part of the services being rendered to the client, system 100 then designates or adjusts the location data for restaurant 708 (and all location data point along route or path 716) to match or be the same as the location data designated in the work request (e.g., client's office 702). In this manner, all future times the employee travels to restaurant 708 during a time frame he/she is interacting with this particular client, system 100 recognizes restaurant 708 as having the same location data as client's office 702, and recognizes the employee as being within the field of acceptability. Alternatively, the rules defining the field of acceptability may be adjusted or otherwise modified to include the location data associated with restaurant 708 (and all location data point along route or path 716) thereby expanding the field of acceptability.

Occasionally, an employee may have to make a one-time trip to, for example, second client facility 706, either with or without the client. In such embodiments, system 100 may detect that the location of the employee is outside of field of acceptability 714 as he/she travels along route 720 to second client facility 706. Upon detection of the deviation from field of acceptability 714, system 100 may transmit a signal, alert, or notification to the employee informing him/her of the deviation, at which point the employee may return to a location within field of acceptability 714 or may submit information or evidence that he/she is deviating from the designated field of acceptability while still performing services pursuant to the work request. System 100 may then again create a temporary field of acceptability 722 which includes route 720 for the work request. Before issuing payment to the employee for rendering services to the client pursuant to the work request, system 100 may require further verification that the employee's deviation from field of acceptability 714 was in fact to provide services for the client pursuant to the work request and authorized by the client. Other legitimate reasons for an employee to travel outside of the designated field of acceptability to render services may arise. Flexibility is provided to clients and employees while allowing for better tracking and verification.

In certain embodiments, a biometric unit on computing device 128 may be utilized to ensure that the employee has not had another person interact with the device or provide the services to the client on the employee's behalf. For example, the employee may be asked to take a picture of themselves, and the photo may be uploaded to a central server so that system administrators may at that time, or at a later time, verify that the actual worker was at the location (and did not, for example, pay someone less money than they were making to sit in for them). In certain implementations, a client may also be prompted for biometric input or prompted to provide a password when the service of the work request has ended, verifying the employee was at the appointment and that service was provided satisfactorily. Once the employee has completed the appointment, they may indicate such completion to the application, such as by selecting an icon that has been visually displayed on computing device 128. Such an action may simply stop the clock from running, or may result in other actions occurring, such as in computing device 128 reporting to a central server that the appointment has been completed, and then receiving back from the central server new instructions for the employee.

The tracking and communications module may allow for tracking information transfer in multiple directions, such as from employee/client to agency, agency to employee/client, employee to client, client to employee, etc. Thus, this module may have a bi-lateral communication function. This bi-lateral transfer of data ensures that the employee is always within the proximity of the client. A record is automatically created when the employee enters the appropriate information upon arrival. Newer information may be gathered with each subsequent visit to build a client record dynamically. Such information may also be gathered at various intervals throughout the day. The client record can be customized by employees according to client needs. As an example, the visiting employee may enter a client number, alpha numeric data, and/or other data into the mobile application or device via an input interface, such as a keypad, touchscreen, to start. A record is then generated and transmitted to the company's administration system over a communication network and alerts the administration or the coordination department that service has just started. As information from the previous trips to the client has been collected, recorded, and updated dynamically, the central server may then automatically respond to the employee's mobile device with a specific list of tasks for the employee to perform based on this information in the client record. Alternatively, information and tasks may be manually inputted by the administration or coordination department and sent to the visiting employee. The information gathered for these client records may then be used for monitoring employee compliance, administrative needs, and proper payment practices.

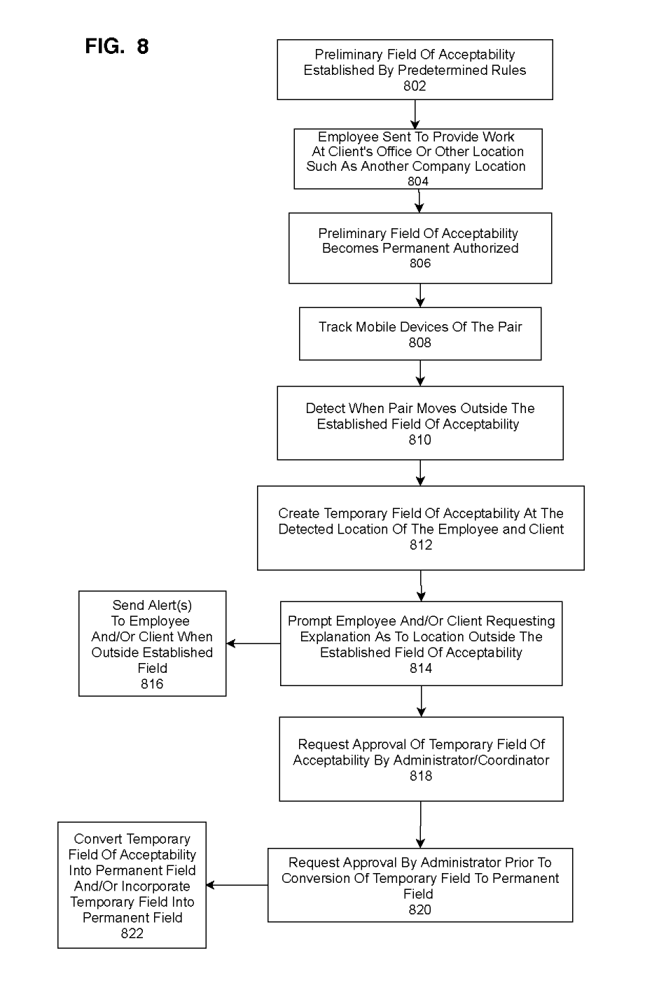

Referring next to FIG. 8, shown is a flowchart illustrating an alternative approach for creating a temporary field of acceptability and updating the permanent field of acceptability in accordance with exemplary embodiments of the invention. A preliminary field of acceptability is initially established by the system in accordance with predetermined rules (Step 802) any time after a work request is received by system 100. At the time indicated in the work request, an employee is dispatched to arrive at, for example, the client's office or place where services are to be provided, such as at another company location (Step 804). In one embodiment, once the employee arrives at the client's office or at another specified location for performing services, the preliminary field of acceptability may be converted to a permanent field of acceptability upon confirmation from the client (e.g., through client module 436), or from the combination of client and employee (Step 806). The system may be configured to then track the mobile devices 128 of the employee or of the employee-client pair if the client agrees (Step 808), such that it detects if the pair moves outside of the established permanent field of acceptability (e.g., outside of any designated locations or routes such as those described with respect to FIG. 7) (Step 810). Upon detection of movement outside of the established field of acceptability, a temporary field of acceptability may be created at new location(s) where the pair traveled (Step 812), as well as the routes traveled to get there. The client and/or employee may then be prompted (e.g., through a user engagement panel on their computing device) to provide an explanation and/or evidence as to the new location and whether or not it is within the scope of the services scheduled to be provided by the employee (Step 814).

For example, the employee may take a picture of the restaurant, and the picture may have metadata evidencing the location of the restaurant, as well as the time the employee arrived there (e.g., with or without the client). Alert(s) may additionally or alternatively be sent to the employee when he/she moves outside of the established preliminary field of acceptability (Step 816). The employee may then be given the option to return to a location within the established field of acceptability or provide an explanation and/or evidence that he/she is still working within the scope of the work request so that the field of acceptability can be adjusted. If it is determined that the employee was within an acceptable field according to the work request or services to be provided, then an adjustment to the field of acceptability may be made upon approval by an administrator and/or coordinator (Step 818). The system may also require that the temporary field of acceptability receive approval by not only the client (and optionally the employee), but also by an administrator of the employee's company (Step 820). Upon approval, the temporary field of acceptability may be incorporated into or converted to a permanent field of acceptability (Step 822). For example, the temporary field of acceptability may have been established because an employee was asked by a client to drive him/her to, for example, an appointment, which may be within the semi-active permanent field of acceptability. If the employee was not within the semi-active permanent field of acceptability, yet was still within the temporary field of acceptability, then the temporary field of acceptability may still apply.

Additionally, an acceptable range beyond any of the fields of acceptability may be temporarily established for either the employee or the pair to travel, such as a reasonable amount of feet away from the field of acceptability upon arrival. For example, a field of acceptability may be established on the route from the client's car to the client's office. Upon accompanying the client to his/her office, the employee notices that his/her vehicle may be low on gas and cannot complete a round-trip back to the client's office without any refilling the gas in his/her vehicle's tank. The next closest gas station may be two blocks away and beyond the approved permanent field of acceptability. In this situation, the employee would be given a prompt or alert in the user engagement panel to explain why he/she moved outside of the field of acceptability. It will be appreciated that the system may establish a temporary field of acceptability for this area outside of the field of acceptability, confirm or verify that it is acceptable for the scope of services being provided, and then adjusting the field of acceptability to include the temporary field such that when an employee travels to the area again the system will recognize it as being within the field of acceptability and not issue an alert or notification. Reducing the frequency and/or number of alerts or notifications substantially improves the accuracy and efficiency of the payment verification system by reducing the data processing required. It will also be appreciated that establishing a reasonable length or distance the employee may travel off of an established route will also reduce the number of incoming prompts, alerts or notifications of this nature to the employee. Different shapes, sizes, and/or colors may be used to represent the permanent field of acceptability and the acceptable range. For example, the permanent field of acceptability may be represented by solid circle or other shape/region and colored green, whereas the acceptable range may be represented as a dotted circle extending beyond the green circle and colored yellow. All other unaccepted areas may be colored red.

A company may track employees during their scheduled work times by using GPS within its tracking and communications device. Additionally, this GPS function will be able to reconcile both time and location problems simultaneously. This GPS function can provide the employee with additional prompts requiring constant interaction with the user engagement panel on the employee device. The main purpose is to ensure that the employee stays within the client's office or other approved location and/or route and is providing service, consulting, or sales in accordance with the work request. For example, intervals will be set up throughout the day which requires both the client and the employee to input information to ensure service is being provided. These intervals may be set for a customized number of minutes, hourly, and so forth. Additionally, the travel path of the visiting employee may be tracked and sent to the central server to ensure that the employee is not taking any detours unrelated to the course of employment.

The tracking performed by the GPS in the employee device may also separate locations of different clients located in close proximity to each other who are clients for the same company to avoid confusion. Since the GPS allows for real-time communication with the central server, it may geofence different fields of acceptability unique to each client. The GPS component may also provide an indirect benefit for coordinators as a scheduling management system by tracking all of the employees who are providing service on-site, so it is apparent which employees are free to cover for other employees.

Contextual information may be used to update the field of acceptability creating an inference of the location of an employee and client. Since the system has previously stored numerous time and location information associated with the pair, any form of action that may not be similar to the usual routine of time and location information may trigger an alert to the administrator or coordinator's system. An identification comparing what tasks were scheduled to be performed and what was actually being performed by the employee may be generated at this time. All or a portion of such information may be transmitted manually or automatically. An employee may prefer manual entry if they anticipate moving outside of the field of the acceptability during his/her shift and wish to update the system beforehand to avoid any future scheduling issues. The employee may be provided a list of common reasons in a drop-down menu or be given a Tillable field in which to explain his/her reasons for the departure from the field of acceptability.

Verification between the employee and client may be completed in a number of different ways. The tracking and communications device between the two may provide a method that is less susceptible to fraud than a simple signature. In certain embodiments, a facial recognition feature may be implemented into the communications device. A client's signature may additionally be required to prove that the employee has arrived and performed all tasks. Voice, facial, retina, or other biometric recognition may also assist in the capture and storage of employee visit time and location information.

Many clients are often located within the same area. Thus, in certain embodiments, geo-fencing may be provided between clients. As such, within a populated area like New York City, many fields of acceptability may overlap one another, particularly if two clients live next door to each other, or within the same location on different floors, such as within an apartment building. In order to avoid the confusion, each client may be geo-fenced by the company. This geo-fencing may provide the necessary differentiation between, for example, two locations within a single structure. Consequently, the fields of acceptability can also be made distinct from one another. This routine may be used to allow a company administrator to establish a virtual boundary around a predetermined client location for purposes of automatically notifying the administrator when an employee crosses the boundary. The tracking and communications module must also have its own bi-lateral communication between the employee and the client. To reduce the chance of fraud, the employee and client may both be required to confirm the visit at simultaneous times. The tracking and communications module may be paired and sync between employee and client. Such synced modules may send all information collected to a central processing server located at the company, which may further analyze and change the client records to match the client's needs. This central server may be used to determine different fields of acceptability based on data collected.

Client privacy is of utmost importance as many laws govern how client information may be disclosed. Certain measures may be implemented to maintain a client's privacy. For example, each client device in the tracking system may provide each client with a client ID. This ID may be used specifically for purposes of tracking a particular client. Additionally, the employee may also be given their own employee ID for purposes of tracking that particular employee. The client IDs in particular will limit all other client information for any user roles other than the system administrator. The ID may be a combination of alphabetical letters and/or numbers that is unique to each client and/or employee. In addition, a tracking system may be controlled to authenticate requesters for tracking information and may only give access to trusted requesters for tracking information or may provide access on an as-needed basis. For example, a requester may provide information to a tracking system regarding a particular procedure, and the tracking system may then obtain interface information about the procedure from another portion of a system to determine when the procedure occurred. An employee may also preset service limitations regarding the time(s) he/she is not available to provide service.

The field of acceptability may be previously established based on a past work request an employee completed or may be based on default parameters as mentioned above. The default parameters may depend on the area, such as within a large city, the time of day, the day of the week, etc. Also, the predetermined rules and the field of acceptability may be updated to respond to real-time circumstances. It is to be understood that “updating” the field of acceptability may be done by association, meaning that at least one of the underlying predetermined rules establishing the field of acceptability have been updated.

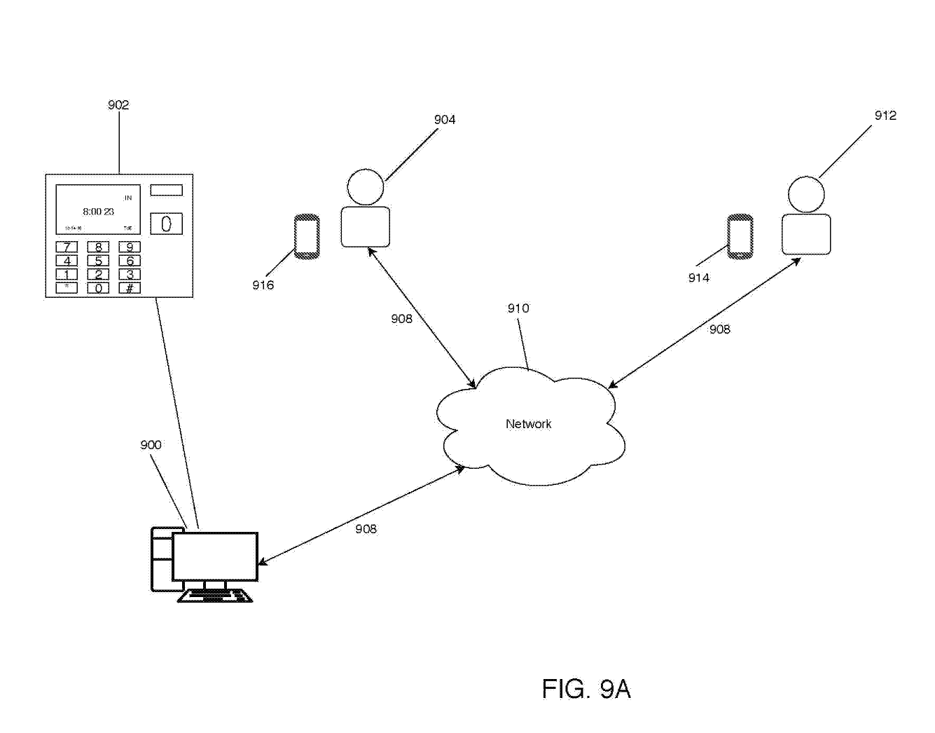

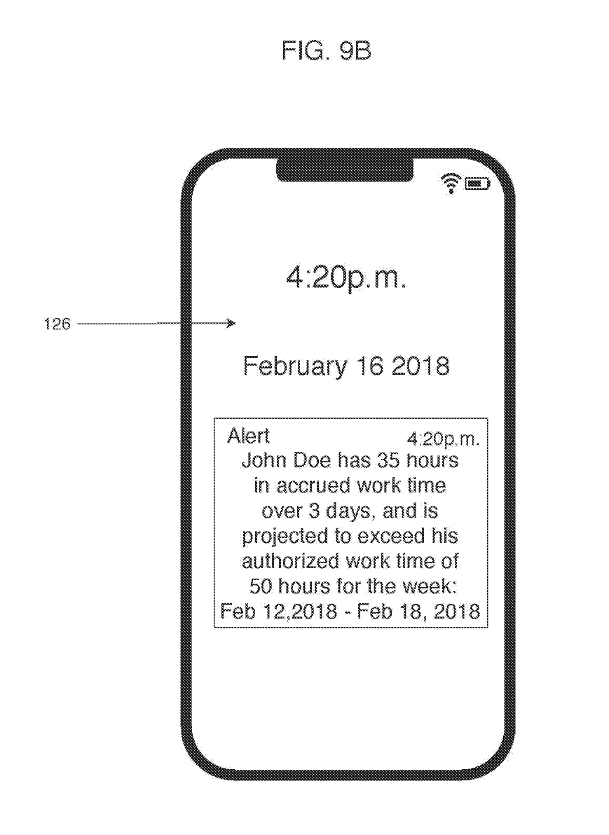

Referring now to FIG. 9A, shown is a schematic diagram of an alternative work-time tracking system 900 according to an exemplary embodiment of the present invention to track the work-time or attendance of an individual 904 locally at predefined area(s) of a workplace. The tracking system includes a time clock system 902 in communication with computing system 900. As discussed herein, individual user 904 can be an employee of a company, an independent contractor, a consultant, a visitor, or any other person.

The tracking system is preferably generally operable to track a user portable electronic device 916 (e.g., the same or similar to computing device 128) carried by or associated with the individual 904 within one or more predefined areas of the workplace in real-time. The computing system 900 is preferably in communication with time clock system 902 and operable to communicate back and forth with the user portable electronic device 916 uniquely associated with individual 904. The tracking system can employ various types of wireless technology 908 (e.g., optical, radio frequency (RF), bar code scanning, ultrasound, global positioning (GPS), wireless local area network (WLAN), ultra-wide band (UWB), ultra-high frequency (UHF), Bluetooth™ Wi-Fi™, cellular-based positioning, infrared (IR), etc. or combination thereof) to track a location of the user portable electronic devices 916, and is not limited based on the subject matter described herein. The tracking system can include or otherwise be connected in communication with a database housed in computing system 900 for recording or storage of collected location data acquired by or received from the tracking system with respect to unique individual identifier uniquely associated with the user portable electronic device 916.

Computing system 900 may be used in conjunction with various systems and associated methodologies disclosed herein, including, for example, computing system 100. Computing system 900 may be used to track employees locally within a workplace, and to determine where employees are spending time throughout the work day. It will be appreciated that companies with highly sensitive information and/or confidential areas may need to monitor which employees accessed certain areas during certain days or at certain times. Additionally, as described herein, employers also need to accurately track and capture employee work hours to ensure they are paying overtime hours which were actually earned. Additionally, companies need to ensure employees are not spending excessive time, for example, at lunch, on smoke breaks, or simply leaving the work facility and getting credit for the time. Various embodiments of fields of acceptability described herein may be used for each work location, and in conjunction with system 900.

In an exemplary embodiment of the invention, time tracking system 900 is customizable and enables inputs from a user such as an employee code, a card swipe, a radio-frequency identification (RFID), a biometric scan, or other identification means in order to identify and track arrival/departure of an employee at/from a work location. RFID uses electromagnetic fields to automatically identify and track tags attached to objects, where the tags contain electronically stored information and collect energy from a nearby RFID reader's interrogating radio waves.

System 900 may be a standalone system, or may be communicatively coupled to computing system 100, and store the employee transaction information (e.g., employee manual inputs and/or information remotely received from remote computing device 916 of employee 904) in database 108 of computing system 100. System 900 may be configured to compare employee transaction information against a customizable profile for each employee/user stored in database 108, and to generate and transmit a notification or other communication to the employee or system administrator based on the comparison in accordance with pre-set rules. System 900, working in conjunction with system 100, thus helps an employer or project manager track, verify, and manage the time spent by individual employees or independent contractors at one or more designated job locations or sites. System 900 can provide more detailed information about an employee's movements at a particular location, and help to minimize fraud, theft, and unnecessary overtime pay.

Current problems associated with time management of hourly workers who remain at a particular location are numerous. Managers often do not know how long their on-site hourly employees are working each week until they receive a report and/or request for payment, which may occur at the end of the week or bimonthly. At that point, the individual employee has purportedly already worked for the number of hours indicated, which may include regular work hours not originally anticipated and/or significant overtime. Even if the manager did not authorize the work, he/she may have difficulty challenging payment, because the employee was not told to stop work. As the business or company has received the benefit of the employee's work, the manager may be deemed to have implicitly acquiesced to it. Additionally, the manager may have to pay the employee regardless and then challenge the payment through legal proceedings. In mid-size or large companies with various time shifts and/or locations, this problem may be compounded, even if hourly employees are supervised locally. Local supervisors may be out on a factory floor or doing rounds, and not in a position to see the specific arrival or departure of individual employees.

Occasionally, dishonest employees may collude to “game the system.” For example, a first employee may leave early and have a second employee “punch out” for him or her. The next day, the second employee may leave early and have the first employee return the favor. While managers sometimes catch such stealing/fraud, they are often unable to do so. Even if cameras are utilized in conjunction with the punch clock, time card, or other device, a manager cannot usually watch the camera at all times, and comparing camera footage to individual check-in or check-out transactions can be extremely time consuming, particularly when a manager does not know that there is a problem or whom he/she should be watching. Also, different employees may have different needs, limitations, and/or personal obligations outside of work that are constantly changing, or an employee may have job requirements that have him/her working offline with respect to the company's network. A manager may simply be unable to sufficiently track the amount of information necessary to effectively manage personnel, let alone to dynamically update such information.

System 900, used with or without system 100, may be implemented through a software application and/or program particularly suited for operation with hand-held devices such as smartphones, Personal Digital Assistants (PDA), mobile computers and/or other multifunctional electronic hand-held devices with compatible operating systems to support the application. Preferably, the hand-held devices comprise a display screen, data entry inputs via touch screen, keyboards and/or voice commands, an operating system to support the application, and a camera to recognize facial features of the user. The hand-held devices communicate with the server through an application installed onto the hand-held device, and is preferably a personal hand-held device specific to the user so as to avoid “buddy punching,” which generally refers to an act where employees at work clock-in and/or punch-in for their co-workers, especially when they are late for work. System 900 helps to eliminate these issues because the hand-held devices used for clocking in and out are personalized to specific employees (e.g., a company issued mobile device or the employee's personal mobile device).

The database employed by the tracking system (e.g., database 108) stores the plurality of registered employees, preset user names, and access codes linked to each user name. Each user name may be tied to an account that may be logged into with a user name and access code or password. Database 108 may be categorized by user name or other categories, may store all attendance recordings for a particular registered user, and may have further information of the registered user such as full name, gender, address, contact number, designation and/or other user particulars.

According to an exemplary embodiment of the invention, each hand-held device may have a mobile identity, assigned by its manufacturer and commonly known as International Mobile Equipment Identity (IMEI), which is typically stored in the hand-held device. The IMEI may be used to differentiate the hand-held device of one user from a hand-held device of another user. Preferably, the owner of each hand-held device is enabled to log into his/her account after installation of the application on the owner's hand-held device. The initial log-in step triggers the matching of the user name and access code to pair up with information in database 108.

In another exemplary embodiment, the user name and access code can be in alphabetical, numerical and/or alphanumerical order. The access code can be provided by the user and/or generated by biometric data such as facial features, fingerprints, palm prints, voice, retinal scans, etc. For facial features, a camera is preferably utilized to capture an image containing facial features of the user. Facial templates are generated on the captured image and verification is performed. The captured image may be used for comparison with a preset facial template stored in the database and verified. Other methods may be used for verification of facial features, such as three-dimensional face recognition and/or blink recognition. In certain embodiments, biometric data may be provided/required with the user log-in.

In still other embodiments, an employee may not have or own a hand-held device with an operating system compatible with the application. In such circumstances, the hand-held devices of employees in managerial levels such as managers, supervisors, etc., are preferably used to permit employees not owning the required hand-held device to clock-in and/or clock-out their attendance. Each mobile identity of the devices may be stored in database 108 along with the clock-in and clock-out operations. The devices may operate in a partial mode, allowing any user to clock-in and/or clock-out for attendance recording. That is, upon recognizing that the hand-held device is an appropriate device by matching the mobile identity of the hand-held device with the registered mobile identity stored in the database, any user, one at a time, may be allowed to log into his and/or her account and clock-in and/or clock-out for attendance recording.

In another exemplary embodiment, the hand-held device may be set as a non-registered device when the mobile identity, which is sent silently to the server, fails to match with any registered mobile identity. If a user provides a registered user name and/or access code, the hand-held device may be permitted to view and/or export the recorded attendance. However, if the user provided username and/or access code fails to match with any preset user name and access code, then the user may be precluded from logging into the application.

In yet another exemplary embodiment, the server may be capable of delivering complex computing and storage capacity to one or more of the applications. The server stores a plurality of registered mobile identities as well as a plurality or preset user identities and linked preset access codes. With a matching user name, access code and mobile identity, a given user will be able to access the program through his/her hand-held device to clock-in and/or clock-out, view the recorded attendance and/or export the recorded attendance. The recorded attendances are sent and stored in the server (e.g., server 102) in communication with the application. Comparing with conventional time attendance recording using punch card, the system and method as described herein can improve manageability, require less maintenance and enable human resources to be more rapidly adjusted to meet fluctuating and unpredictable business demand.

In still a further exemplary embodiment of the invention, the hand-held devices further comprise a Global Positioning System (GPS). The GPS is preferably used to detect and identify locations of a user at each clock-in and/or clock-out occasion and the detected location is preferably tagged with the related clock-in and/or clock-out occasion. As a result, time and location of the user may be recorded during attendance recording. The recorded attendances can be viewed and/or exported as notifications to appropriate management personnel or for printing. The recorded attendance data is preferably stored in database 108, categorized based on at least user name or identity, and may be exported into a format for printing. The attendance data may have user information along with start and end dates of working days and clock-in and/or clock-out time with respect to specific locations detected by the GPS. The attendance data may be transmitted to the hand-held devices that may communicate with the computing system and database via a communication network 910. Preferably, communication network 910 is a wireless network connection established via a wireless protocol cloud. However, one skilled in the art will appreciate that this technology may be substituted with other known wireless protocols and standards.

In another exemplary embodiment of the invention, time attendance tracking system 900 is a standalone system which comprises a server, database, and at least one mobile device, similar to system 100. Preferably, the server is in communication with a database for storing a plurality of mobile identities and user accounts, in which the mobile identities are categorized by user accounts. Each registered mobile device may communicate with the computing system and database, and have a mobile identity and a mobile application configured to provide a selection of options for the user upon activation of the application. The user may be granted a certain level of accessibility depending on the user's mobile phone identity and the level of the user's account.

Customizable time tracking system 900 is directed at addressing and solving the problems associated with existing systems by linking employee check-in/checkout to a dynamically updated database and computing system which, based on pre-set preferences and customizable user profiles, outputs various notifications to employees and managers. Each customizable employee profile can include personal information such as, for example, birthday, date of hire, contact information, age, hire date, favorite songs, any specific allowances (e.g., handicapped, hearing impaired, etc.). The employee profiles can also include the employee's regularly scheduled working hours (e.g., typical/assigned arrival time, departure time, lunch break time, etc.), allowances such as regularly scheduled doctors' appointments, and pre-set time allowance for deviation(s) from the employee's regular schedule. For example, a manager may wish to know when an employee arrives to work more than ten or fifteen minutes late or leaves more than half an hour beyond his/her normal departure time, but may not want to be notified if the employee is five minutes late arriving or ten minutes late departing.

The system is configured to, each time an employee checks (punches) in or out, record the transaction in the database with a corresponding timestamp, and compare the transaction and timestamp with the customizable employee profile corresponding to the particular employee checking in or out. Based on this comparison, the system is configured to send outputs (e.g., written notifications or other communications) to employees, managers, independent contractors, and/or system administrators. The outputs can be sent as text messages to mobile devices, emails to email addresses, and/or phone calls which leave automated recordings as voicemails.

The system is aimed not only at helping managers, but improving employee morale. For example, the outputs can include, at the time of each transaction, singing Happy Birthday to the employee or playing the employee's favorite song on the employee's Birthday or within 24 hours prior thereto. Notification(s) may be sent to other of the employee's colleagues announcing his/her birthday once system 900 confirms he/she is at the office. Such functionality helps foster office comradery and moral. Notifications may also be sent as reminders to employees informing them of an upcoming holiday or vacation pre-set in system 900, or a manager's message regarding, for example, approval for early departure.

System 900 may also be configured to notify a manager/system administrator (MSA) when an employee checks in/out at a time which is not within the employee's regularly scheduled working hours or within a pre-set time allowance for any deviation(s) from the employee's regular schedule. The system can notify the MSA when the employee is projected to exceed a 40 hour work week (or other amount such as 50 hours, as shown in FIG. 9B) or any work amount sufficient to qualify for overtime. Such notifications can also be sent to the employee and copied to the manager, informing the employee that he/she must leave work after a specific number of hours so that the employee will not incur over-time or simply work beyond a predetermined number of authorized hours. These notifications may put employees on notice that they are not authorized to work beyond the total time indicated. Similarly, system 900 may be configured to notify the MSA when the employee does not swipe in or out within pre-set time period of a regularly scheduled start time or a regularly scheduled end time, or due to any aberrations in the employee's working time (e.g., when the employee is not within a field of acceptability, as defined herein, for the particular work location).

Various verification technologies can be utilized in operative communication with the system, including, for example, a camera device configured to record and take photographs each time an employee checks in or out and store the photograph in the database, facial recognition software, and/or fingerprint technology. Remote access to system can include an application running on a mobile phone. System 900 may be configured to allow employees to remotely request temporary or permanent change to settings through their mobile devices, subject to manager approval. MSA may also be allowed to authorize or deny each request remotely.

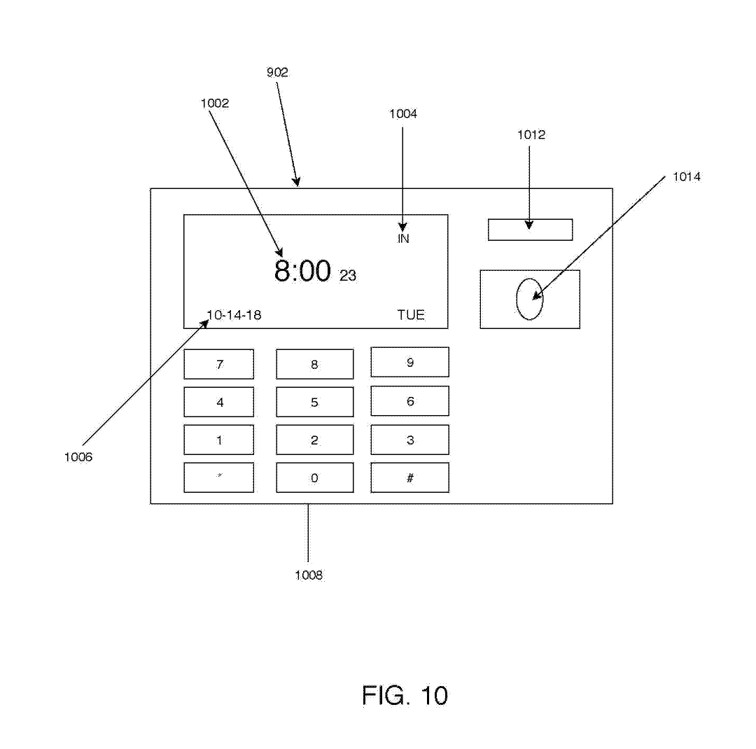

Referring to FIG. 10 with continued referenced to FIG. 9A, illustrated is time clock mechanism 902 for use in accordance with an exemplary embodiment of the invention, which can be generally operable to detect the presence of a portable tracking device 916, or receive input from individual 904 using a card reader 1012, a biometric scanner 1014, a keypad entry via keypad 1008, etc. for tracking the location of the individual 904 during a specific time period. The portable electronic device 916 can include or be in the form of a passive or active identification tag or badge, cellular or mobile phones, etc. or combination thereof, having a processor connected to an interface. The interface can include various input devices generally operable to receive instructions from the individual 904 for communication to computing system 900, as well as an output device generally operable to illustrate feedback to the individual 904 as communicated from the computing system 900. An example of the input device includes a keypad, microphone, etc. that when triggered instructs the portable electronic device 916 to communicate instructions to the computing system 900. An example of the output device can include a visual indicator (e.g., LCD screen, LED light, etc.) or an audible indicator or combination thereof operable to communicate feedback or electronic formatted message content communicated from the computing system.

The time clock system 902 can be generally operable to track or record a current date 1006 and clock-in 1004 (i.e., start) or clock-out (i.e., end) associated with a unique individual identifier at a place of employment. The time clock system 902 can be operable to convert information with respect to actions by the individual 904 to clock-in or clock-out into an electronic format for communication to other systems (e.g., system 100) for developing accounting records and reports, to generate payroll, etc. Time clock system 902 can be hard-wired or wireless communication with other parts of computing system 900. Time clock system 902 can include an internal clock mechanism 1002 to track current date 1006 and time 1002, and employ readers or scanners 1012, 1014 operable to read information data associated with individual identification cards or tags or badges. The time clock system 102 can further include a local display 1004 to visualize a category of the action (e.g., clock-in, clock-out, etc.) associated with a unique individual identifier, as well as the recorded current time and date for time and attendance purposes for storage and retrieval with a database. Time clock system 902 can also employ other technologies to verify the unique identification associated with an action of the individual 104, including facial recognition, fingerprint scanning 1014, retina scanning, etc. and is not limited based on the subject matter described herein.

Computing system 100 can be generally operative to receive, process, and convey information in the form of electronic communications to and from tracking system 902. An example of the computing system within tracking system 902 can generally include a memory having a series of computer readable program instructions for execution by a computer processor. The example memory can be a computer program product including a non-transitory, tangible, computer readable medium of varying type generally operable to store electronic formatted data or information and computer readable program instructions accessible and readable by the computer processor. In certain embodiments, the memory can be accessible by a controller remote computing device 914 of an administrator 912 or the user portable electronic device 916 carried by the individual 904 via network 910.

The computer-readable instructions can comprise a programming code for execution by the computer processor. The programming code can be embodied in software stored on the memory independent of or in combination with software embodied in firmware or dedicated hardware. The computer program product may be stand-alone or integrated as part of the main controller. As used herein, the term tangible, non-transitory computer readable storage medium can be expressly defined to include any type of computer readable storage device and/or storage disk and to exclude propagating signal media and to exclude transmission media. As used herein, “tangible, non-transitory computer readable storage medium” and “tangible, non-transitory machine-readable storage medium” can be used interchangeably.

Examples of the memory can include, but are not limited to, random access memory (RAM), read only memory (ROM), Synchronous Dynamic Random Access Memory (SDRAM), Dynamic Random Access Memory (DRAM), EEPROM, flash memory, a cache, compact disc (CD), digital versatile disc (DVD) or other optical storage, magnetic cassettes, magnetic tape, magnetic disk storage or other magnetic storage devices, a hard drive, a flash memory, or any other medium which can be used to store the desired electronic format of information or program instructions for a duration and which can be accessed by the computer processor or at least a portion of the computing system.

The computer processor can include hardware to execute one or more tasks as defined by the computer readable program instructions, and can include, for example, part of a computer server, a laptop or desktop, a mobile device (e.g., a cell phone, a smart phone, a tablet such as an IPAD™), a personal digital assistant (PDA), an Internet appliance, or any other type of known computing device. For example, the computer processor can be implemented by one or more integrated circuits, logic circuits, microprocessors or controllers from any desired family or manufacturer.

The memory and computer processor as referred to herein can be stand-alone or integrally constructed as part of various programmable computing devices of various types, including for example a cache, a desktop computer or laptop computer hard-drive, field-programmable gate arrays (FPGAs), application-specific integrated circuits (ASICs), application-specific standard products (ASSPs), system-on-a-chip systems (SOCs), programmable logic devices (PLDs), etc. or the like and any combination thereof operable to execute the instructions associated with implementing the method (discussed later) of the subject matter described herein.

The controller of computing system 902 can also be configured to communicate instructions to and from the controller remote computer devices 914 and the employee portable electronic devices 916. Examples of remote computer devices 914 and user portable electronic devices 916 can include: a mobile telephone; a computer such as a laptop type; a Personal Digital Assistant (PDA) or mobile phone; a notebook, tablet or other mobile computing device; or the like and any combination thereof. The functionalities described herein may be implemented through a stand-alone computer program product or as an application configured for execution by one or more of the remote computing devices 914, 916. The application (e.g., webpage, downloadable applet or other mobile executable) can generate the various displays or graphic/visual representations described herein as graphic user interfaces (GUIs) or other visual illustrations, which may be generated as webpages or the like, in a manner to facilitate interfacing (receiving input, generating graphic illustrations) with users via the remote computing device(s) 914, 916.

The network 910 can facilitate transmission of electronic format or digital data. An example network 910 can be a wired interface (e.g., a data bus, a Universal Serial Bus (USB 2.0 or 3.0) connection, etc.) and/or a wireless interface (e.g., radio frequency, infrared, optical, near field communication (NFC), etc.), a wide area network (WAN); a local area network (LAN); the Internet; a cloud-based computing infrastructure of computers, routers, servers, gateways, etc.; or any combination thereof associated therewith that allows the computing system or portion thereof to communicate with various computing devices described above.

With respect to the example of the network 910 as including a cloud-based infrastructure, the computing system 100 can share information via web-based applications, cloud storage and cloud services. For example, a Web-based portal may be used to facilitate access to information, etc. The computing system can illustrate the Web-based portal as a central interface to access information and applications, and data may be viewed through the Web-based portal or viewer. Additionally, data may be manipulated and propagated using the Web-based portal, which can be accessible locally (e.g., in an office) and/or remotely (e.g., via the Internet and/or other network or connection).

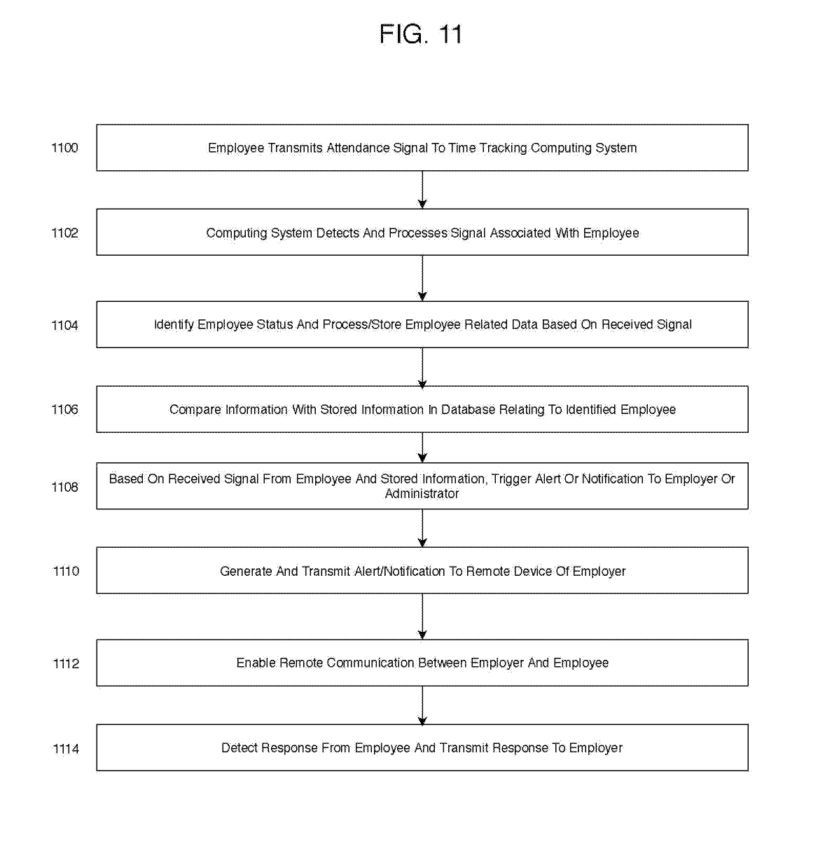

Referring now to FIG. 11, shown is a flowchart illustrating exemplary steps for tracking, monitoring, and processing the status of an employee's attendance or absence from work. It will be understood that the sequence of the acts or steps of the method as discussed herein can vary, and that the method may not require each act or step, or may include additional acts or steps not disclosed herein. It will also be appreciated that one or more of the steps of the methodologies disclosed herein can be represented by one or more computer program modules of computer-readable program instructions stored in the memory of the computing system and implemented using coded instructions (e.g., computer and/or machine-readable instructions). The terms module and component as referenced herein can generally represent program code or instructions that causes specified tasks when executed on the computer processor. The program code can be stored in one or more computer readable mediums that comprise the memory.

In one embodiment the system automatically detects presence of a portable electronic device 916 uniquely associated with and carried with the individual 904 at the workplace. As a user or employee enters the workplace and comes within a predetermined distance of the time clock system 902, a signal is transmitted, either manually or automatically, by the user (i.e., card swipe, biometric scan, RFID signal, voice command, or remotely from the user's handheld device) to computing system 900 and/or time clock system 902 (Step 1100). Time clock system 902 can receive signals from user portable electronic device 916 automatically once the employee is within a specific predetermined distance of time clock system 902. The computing system detects and processes these signals from the user or user device 916 (Step 1102). User device 916 may transmit a location or presence signal including individual identifier data associated with device 916. At Step 1102, time clock reader 1002 may also detect/receive the attendance signal, and process the signal to identify the unique individual identification associated with a location of the user/employee (e.g., using location identification technology such as that disclosed above with respect to system 100). The system may then identify the employee's status, and process and store the employee related data based on the received signal (Step 1104). Preferably, user device 916 at least periodically transmits an attendance signal for receipt by tracking system 900. Alternatively, user device 916 can interact in other ways (e.g., passively) with tracking system 900. The type of communicative interaction in detecting location or attendance data from user device 916 may vary.

In certain embodiments, system 900 may retrieve from a database (e.g., database 108), stored information data associated with a predefined or predetermined work-shift in electronic or digital format. The stored information may include a list of unique identifiers corresponding to the individuals 904 scheduled to work for a particular time period or time frame, with a start time (e.g., a clock-in time) and an end time (e.g., a clock-out time) for the individual 904 to begin and end work on a particular day at the workplace. The start time and end time can be distinct time values or threshold value ranges. The work-shift can be stored in electronic format in the database for retrieval by a microprocessor of a main controller of computing system 900. System 900 may then compare the stored information to the user information associated with the location or attendance data to verify the employee/user's status (Step 1106).

In certain embodiments, system 900 may record a registration time (e.g., a clock-in time) associated with the unique individual identifier of the individual 104 at the predefined area of the workplace. System 900 may be configured to compare the list of individual identifiers of individuals 104 tracked to have registered (e.g., clocked-in) at time clock system 902 to the list of individual identifiers of individuals 104 scheduled per the predefined work-shift. Based on the signals received from the employees and the stored information in the database, the system may trigger an alert or notification to an employer or administrator (Step 1108) if there are discrepancies. The system may generate and transmit the alerts/notifications to remote devices of the employer (e.g., device 914) (Step 1110), and enable remote communication between the employer and employees (Step 1112). The system may also give the employee an option to provide a response, and detect any such response from the employee and transmit it to the employer (Step 1114).

In certain embodiments, system 900 may be configured to detect or identify individual identifiers associated with individuals 904 for whom no registration times have been recorded at time clock system 902 (e.g., at Step 1104). Computing system 900 may also be configured to execute program instructions to search a work schedule database of and identify an individual 104 present at the workplace who has not recorded a registration time with clock system 902, manually or remotely. For such individuals, system 900 can transmit a feedback signal or communication indicating that system 900 has recorded locative data indicating the presence of one or more user portable electronic devices 916 and/or unique identifiers associated with one or more unregistered individuals 104 within the workplace at the predefined scheduled time period of the work-shift. It will be appreciated that this will help avoid later disputes over hours if an employee forgets to “punch-in”, and will help enhance security as such signals may be sent to supervisors or managers currently at the work location. The transmission of the feedback signal from tracking system 900 can include data indicative of the last recorded location data with respect to the detected presence of the individual identifiers and/or user portable electronic device 916 associated with the individuals 904 who have not registered for work. The system can identify and create a list of such individuals. In certain embodiments, computing system 900 may send an alert or notification to the user portable electronic devices 116 informing such individuals that they need to register at clock system 902. Such alerts or notifications can be visual notifications, vibratory notifications, audible notifications, or combinations thereof on the remote computing devices of such individuals 904, and require acknowledgement or feedback from the individuals 104 via their user portable electronic devices 916.

In certain embodiments, the system may receive a feedback signal from the user portable electronic device 916, such as instructions operative to automatically cause time clock system 902 to record the registration time for the individual 104 at a start time in accordance with the predefined work-shift. The feedback signal transmitted from the user portable electronic device 916 may be operative to automatically cause time clock system 902 to record the registration time of the individual 904 per an input time included in the feedback signal. In another example, the feedback signal may be triggered from activation of buttons with instructions or information data indicative of individual feedback to acknowledge or decline, respectively, the request to record a registration time at the time clock system 902.

In certain embodiments, the system may also detect transmission of a threshold number of electronic communications without detection of receipt of transmission of the feedback signal from the user portable electronic device 916. In response to exceeding a threshold, the system may automatically transmit an electronic escalation communication or message to a predefined recipient, such as a manager, supervisor, administrator, etc., or to the user portable electronic device 916, per predefined program instructions stored in the database.

In certain embodiments, the system may be configured to store an authorized work time amounts for each employee over a given time period (e.g., day, week, month, year, etc), and additionally monitor the average amount of time the employee or independent contractor works per week. In this manner, the system can, by continuously tracking the employee's or independent contractor's worktime over the time period, predict whether the employee or independent contractor is will likely go over the authorized worktime. For example, an employee may normally work forty-five hours per week, five days per week, and average ten hours per day. The employee may have authorization in the system to work more than this (e.g., fifty hours per week) if he/she desires. However, if one week the employee has worked thirty five hours in three days, then the system may predict that if the employee works his/her normal ten hours per day for the remaining two days, he/she will go over the fifty hour authorization work time. The system may also be configured to make the prediction if the employee averages at least 80% his/her average worktime per day for the remaining two days (e.g., 35+0.8*10+0.8*10=51>50). Various configurations and settings may be used. If the system predicts that the employee's actual worktime will exceed the authorized worktime amount during the time period, then it may generate and transmit a notification to a supervisor computing device (126, 912) which indicates that the actual worktime of the employee is predicted to exceed the authorized worktime (FIG. 9B). The system may then receive from the supervisor computing device 126, 912, an authorized adjustment of the authorized worktime or a rejection, and transmit to an employee computing device 132 of the employee, a decision. The decision may include the authorized adjustment of the authorized worktime or the rejection.

In certain embodiments, when time clock system 902 detects the presence of an attendance signal generated by the employee computing device 132, it may identify the employee's location based on location identifier 408 of computing device 132. Time clock system 902 may display on an interface thereof, information associated with the employee stored in database 108, such as a total work time of the employee thus far during the time period or a total number of hours remaining before the employee is entitled to overtime pay. Time clock system 902 may play music associated with an employee profile corresponding to the employee and stored in the database. The employee profile may include, for example, the employee's birthday or a greeting song for the employee. Computing system 100, 900 may, responsive to not detecting the attendance signal and detecting a current time at or later than a predetermined start time of a work request with which the employee is associated, automatically generate and transmit an electronic communication to at least one of the employee computing device or the supervisor computing device. The electronic communication may a vibratory alert, a visual notification, or an audible alert at the employee computing device or the supervisor computing device. The electronic communication may prompt a feedback signal from the employee computing device acknowledging the decision.

In this manner, employers, managers, and supervisors can remotely manage their employees, and avoid disputes by authorizing or rejecting employee or independent contractor overtime before the overtime (or additional hours) are worked. It will be appreciated that once hours are worked by an employee or independent contractor, the employer is placed in a more difficult situation because he/she has received the benefit of the work, and may be under an obligation to pay for the additional hours or overtime. But if the employee or independent contractor is warned ahead of time and acknowledges the decision of the supervisor, then the additional work hours are unlikely to occur. employer may not be responsible

It will be understood that the phrases or terminology employed herein is for purposes of description and not of limitation. While the present invention has been shown and described with reference to various preferred embodiments, those skilled in the art will readily appreciate that various changes and/or modifications may be made without departing from the spirit and scope of the invention as defined by the claims. Any exemplary embodiments described herein are merely illustrative, and many variations can be introduced without departing from the spirit of the disclosure or from the scope of the appended claims. For example, elements and/or features of different exemplary embodiments may be combined with each other and/or substituted for each other. The scope of the invention, therefore, shall be defined solely by the following claims, and it will be apparent to those of skill in the art that numerous changes may be made in such details without departing from the spirit and the principles of the invention.

It will be appreciated that various embodiments of systems and methods disclosed herein provide automated employee tracking and verification through computing devices, allow for greater communication between clients, employees, coordinators, and/or administrators through dynamically deploying relevant information through computing devices, and enable scheduling work requests, coordinating service of them, dynamically updating and facilitating changes to work requests, and providing real-time information to all parties during client visits.

What is claimed is:

1. A system for tracking work-time, the system comprising:
a server communicatively coupled to one or more computing devices via a network, wherein at least one of the one or more computing devices includes a location identifier configured to generate location data corresponding to one or more locations, and wherein the server includes at least one non-transitory computer-readable storage medium with computer-readable instructions stored therein, a database, and a processor for executing the computer-readable instructions to:
receive, from at least one of the one or more computing devices, a work request, the work request including one or more designated times and one or more designated locations;
establish, by the server, a field of acceptability based on one or more predetermined rules, wherein the field of acceptability includes a first portion of aggregate data comprising at least one of (i) one or more location data sets corresponding to the one or more designated locations or (ii) one or more time-location data sets corresponding to the one or more designated times and the one or more designated locations;
receive, from an employee computing device of an employee assigned to the work request, an actual location data set or an actual time-location data set generated by the location identifier during performance of the work request;
continually determine compliance or noncompliance with the work request by comparing, in accordance with the one or more predetermined rules, (i) the actual location data set with the field of acceptability, or (ii) the actual time-location data set with the field of acceptability; and
compute a total work-time of the employee on the work request based on at least one of determined compliance or determined noncompliance of the employee with the work request.

2. The system according to claim 1, wherein the processor further executes the computer-readable instructions to:
receive, from a plurality of computing devices, additional aggregate data comprising additional location data or additional time-location data;
store in the database the additional aggregate data; and
adjust the field of acceptability by including or excluding at least a portion of the additional aggregate data in accordance with the one or more predetermined rules.

3. The system according to claim 1, wherein the processor further executes the computer-readable instructions to:
responsive to determining noncompliance of the employee with the work request for a predetermined time period, transmitting a conditional rejection to the employee computing device, wherein the conditional rejection prompts the employee to submit employee relevant data.

4. The system according to claim 3, wherein the conditional rejection prompts the employee to submit employee relevant data containing evidence of or one or more reasons justifying the employee not being within the field of acceptability, wherein the one or more reasons include at least one of text data, audio data, image data, or video data.

5. The system according to claim 4, wherein the employee computing device includes a geo-aware camera configured to enable the employee to capture data for submission to the system as at least a portion of the employee relevant data indicative of a reason for failing to be within the field of acceptability, wherein the captured data includes one or more geotagged photos having geotag information and timing information to provide evidence that the employee's one or more reasons are legitimate.

6. The system according to claim 5, wherein the processor further executes the computer-readable instructions to:
receive one or more verifications of the employee relevant data from one or more additional employees having firsthand experience with the employee relevant data through at least one of a plurality of computing devices, wherein the firsthand experience is identified as the one or more additional employees being or having been within a predetermined distance of one or more locations associated with the employee relevant data.

7. The system according to claim 1, wherein the processor further executes the computer-readable instructions to:
responsive to determining noncompliance with the work request, displaying, on the employee computing device, an indicator indicative of the employee not being within the field of acceptability.

8. The system according to claim 1, wherein the work request is associated with a client, and the processor further executes the computer-readable instructions to:
establish a temporary field of acceptability corresponding to one or more new locations associated with the work request for a temporary time period,
wherein determining compliance or noncompliance with the work request includes comparing the actual location data set received with the temporary field of acceptability during the temporary time period.

9. The system according to claim 8, further comprising
a client computing device having a client module configured to transmit information from the client confirming completion of the work request by the employee, wherein the information includes at least one of a signature, a PIN, a passcode, a fingerprint, biometric data, or other means for confirming completion of the work request, and wherein the information includes at least a timestamp or location data and is provided at one of a start of the work request, during performance of the work request, or upon completion of the work request.

10. The system according to claim 1, wherein the processor further executes the computer-readable instructions to:
store a customized profile corresponding to the employee in the database;
receive, from the employee, at one of the designated locations, employee data comprising at least one of a card swipe, a personalized code, an RFID or a biometric scan;
compare the employee data with the customized profile; and
confirm attendance of the employee at the designated location based on comparing the employee data received with the customized profile.

11. The system according to claim 1, wherein the processor further executes the computer-readable instructions to at least one of:
(i) transmit, to a computing device associated with a manager or system administrator, a notification when the employee checks in or checks out at a time which is not within the employee's regularly scheduled working hours or within a pre-set time-frame for any deviation from a regular schedule of the employee;
(ii) transmit, to the computing device associated with the manager or the system administrator, a notification when the employee is projected to exceed a predetermined number of work hours in a given time frame; or
(iii) transmit, to the computing device associated with the manager or the system administrator, a notification when the employee does not locally or remotely check in or check out within a pre-set time period of a regularly scheduled start time or a regularly scheduled end time.

12. The system according to claim 1, wherein the one or more location data sets corresponding to the one or more designated locations include one or more routes to or from the one or more designated locations.

13. The system according to claim 1, wherein the work request includes designated location data associated with the one or more designated locations or designated time-location data associated with the one or more designated times, the location identifier includes a global positioning system (GPS) receiver, the server includes at least one geographical information system (GIS), and the processor further executes the computer-readable instructions to:
convert, by the GIS, the designated location data into designated geo-location coordinates by geo-coding the designated location data;
query the database to determine whether the database contains the one or more predetermined rules for the designated geo-location coordinates by referencing a unique ID number or a work request identifier; and
receive the actual location data set from an employee module, wherein the actual location data set comprises at least actual geo-location coordinates.

14. The system according to claim 13, wherein the processor further executes the computer-readable instructions to:
confirm compliance with the work request by comparing at least the one or more actual geo-location coordinates with the designated geo-location coordinates in accordance with the one or more predetermined rules.

15. The system according to claim 14, wherein the field of acceptability is further established by additionally creating a buffer parameter for the designated geo-location coordinates, wherein the buffer parameter is configured to contain a plurality of coordinates within a predetermined distance of the designated geo-location coordinates, wherein the one or more designated locations are locations of a company where the employee works.

16. A system for automated management of work-time, the system comprising:
a server communicatively coupled to one or more computing devices via a network, wherein the server includes at least one non-transitory computer-readable storage medium with computer-readable instructions stored therein, a database, and a processor for executing the computer-readable instructions to:
store, in the database, an authorized worktime amount for an employee over a time period;
continuously track, during the time period, an actual worktime of the employee;
predict, during the time period, whether the actual worktime of the employee will exceed the authorized worktime amount during the time period;
responsive to predicting that the actual worktime will exceed the authorized worktime amount, generating and transmitting a notification to a supervisor computing device indicating that the actual worktime of the employee is predicted to exceed the authorized worktime; and
receiving, from the supervisor computing device, an authorized adjustment of the authorized worktime or a rejection; and
transmitting, to an employee computing device of the employee, a decision, wherein the decision includes the authorized adjustment of the authorized worktime or the rejection.

17. The system according to claim 16, further comprising:
a stationary monitoring device for detecting presence of an attendance signal generated by the employee computing device, wherein the employee computing devices includes a location identifier configured to generate location data corresponding to one or more locations, and the processor executes the computer-readable instructions to:
detect the attendance signal associated with the employee;
responsive to detecting the attendance signal, at least one of:
(i) generate and display, on an interface of the stationary monitoring device, information associated with the employee, wherein the information includes at least one of a total work time of the employee or a total number of hours remaining before the employee is entitled to overtime pay;
(ii) play music associated with an employee profile corresponding to the employee and stored in the database, wherein the employee profile includes at least one of the employee's birthday or a greeting song for the employee;
(iii) identify a current geolocation of the employee computing device and store the geolocation in the database; or
(iv) display, on either an interface of the stationary monitoring device or an interface of the employee computing device, an indicator representative of the employee being outside a field of acceptability based on one or more predetermined rules, wherein the field of acceptability includes aggregate data comprising at least one of (a) one or more location data sets corresponding to one or more designated locations or (b) one or more time-location data sets corresponding to the one or more designated times and one or more designated locations.

18. A system according to claim 17, wherein the processor further executes the computer-readable instructions to:
responsive to not detecting the attendance signal and detecting a current time at or later than a predetermined start time of a work request with which the employee is associated, automatically generate and transmit an electronic communication to at least one of the employee computing device or the supervisor computing device.

19. The system according to claim 18, wherein the electronic communication triggers at least one of a vibratory alert, a visual notification, or an audible alert at the employee computing device or the supervisor computing device.

20. The system according to claim 16, wherein the electronic communication prompts a feedback signal from the employee computing device acknowledging the decision.
